(19) United States
(12) Patent Application Publication
(10) Pub. No.: US 2023/0194675 A1
(43) Pub. Date: Jun. 22, 2023

(54) LIGHT SCANNING APPARATUS, ADJUSTMENT METHOD OF LIGHT SCANNING APPARATUS, AND STORAGE MEDIUM

(71) Applicant: Dolphin Co., Ltd., Koshigaya (JP)

(72) Inventor: Zhihui DUAN, Koshigaya (JP)

(21) Appl. No.: 18/082,063

(22) Filed: Dec. 15, 2022

(30) Foreign Application Priority Data
Dec. 16, 2021 (JP) 2021-204369

(51) Int. Cl. G01S 7/481; G01S 17/10; G01S 7/4865; G02B 26/10

(52) U.S. Cl. CPC G01S 7/4817; G01S 7/4811; G01S 7/4816; G01S 7/4865; G01S 17/10; G02B 26/101; G02B 26/105

(57) ABSTRACT

A scanning assembly configured to reciprocally scan a predetermined scanning range in a first direction with a laser beam by projecting the laser beam reflected by a reflective member periodically driven by an actuator to rotate reciprocally, a retrospective optics configured to guide a light incident on the reflective member to the light detector, and a reflective area configured to specularly reflect the laser beam are provided. Driving frequency of the actuator is adjusted such that a time interval between a first reference timing determined based on detection timing of a light reflected from the reflective area and a second reference timing determined based on a timing when the scan reaches a predetermined end of the scanning range substantially become equal in a forward scan path and a backward scan path of the reciprocating scan passing through the reflective area.

### TECHNICAL FIELD

{0001} The present invention relates to a light scanning apparatus configured to perform scanning with a laser beam, an adjustment method of such light scanning apparatus, and a non-transitory machine-readable storage medium storing program instructions to cause a processor to execute adjustment of such light scanning apparatus.

### BACKGROUND

{0002} Object detecting apparatus has been conventionally used to detect laser beam reflected by an object by irradiating laser pulse outward, thereby detecting a distance to the object along the optical path of the laser beam and the object itself. Such an object detecting apparatus is called LiDAR (Light Detection and Ranging).

In recent years, such LiDARs have been utilized in various fields such as autonomous driving of automobiles.

{0003} One of the important components in a LiDAR is an optical scanning assembly for scanning within a predetermined field of view with laser light. An optical scanning assemblies in which a mirror is reciprocally rotated by an actuator and a laser beam is reflected by the mirror to be projected is known. Such an optical scanning assembly is described in, for example, patent literatures (PTL) 1 to 3.

In addition, PTL4 and PTL5 each discloses an actuator that utilizes a spring, a magnet and a coil and realizes reciprocal rotational driving by applying a driving signal to the coil.

### CITATION LIST

### {Patent Literature}

{0004} {PTL1} Japanese Patent No. 6,518,959
{PTL2} Japanese Patent No. 6,651,111
{PTL3} Japanese Patent No. 6,830,698
{PTL4} U.S. Pat. No. 5,280,163
{PTL5} U.S. Pat. No. 6,547,145

### SUMMARY

{0005} PTL1 and PTL2 each discloses an actuator in which a movable member is provided with a restoring force to its neutral position, the movable member is moved from the neutral position against the restoring force by applying a force to the movable member by a driving signal applied to a coil, and the driving signal is periodically reversed to periodically reverse direction of the force, thereby periodically and reciprocally rotating the movable member. The restoring force can be realized by, for example, a metal torsion spring or a magnetic force between a magnet and a magnetic material.

The actuators described in PTL4 and PTL5 have the same basic mechanism as above.

{0006} In an actuator that reciprocally rotates a movable member against a restoring force to its neutral position as described above, it is known that the movable member has a natural resonant frequency (resonance point) regarding to the rotational movement. It is also known that the movable member can be driven with lower power consumption when setting the driving frequency, which is the inverse of the period in which the direction of the force applied to the movable member is reversed, at a value close to the resonant frequency.

{0007} PTL4 and PTL5 disclose configurations for adjusting the driving frequency. The outline is that: a detection magnet fixed to the movable member and such a detection coil that distance between the detection coil and the detection magnet varies according to movement of the movable member are used; back electromotive force generated in the detection coil according to movement of the detection magnet is detected; and polarity of the drive signal is reversed at timings when the back electromotive force becomes zero, that is, the movable member stops.

However, this method has a problem that the back electromotive force is easily affected by noise of circuits, distortion of waveforms, and the like, and thus it is difficult to precisely determine timings for reversing polarity of the drive signal.

{0008} In order to solve such a problem, it is conceivable to dispose encoder elements for optically or magnetically detecting movement of the movable member on the movable member or its peripheral member, and measure rotation angle of the movable member by the encoder element. In this method, it is possible to more accurately measure the timings at which the movable member stops during the reciprocating rotation.

However, there is a problem in this method that adopting a specific encoder element causes increase on the number of components and needs higher requirement of assembly accuracy, which leads to a higher cost. In addition, it is necessary to correct measurement errors due to changes in surrounding environments such as temperature, and circuits for the correction also increase cost.

{0009} One purpose of the present invention is to solve these problems and to realize a light scanning device configured to scan a predetermined scanning range (field of view) with light using an actuator that reciprocally rotates a movable member at low power consumption and low cost.

{0010} One aspect of the present invention relates to a light scanning apparatus, including: a scanning assembly configured to reciprocally scan a predetermined scanning range in a first direction with a laser beam by projecting the laser beam reflected by a reflective member periodically driven by an actuator to rotate reciprocally, the reciprocating scan including a forward scan path and a backward scan path; a light detector configured to receive and detect light at a predetermined position; a retrospective optics comprising the reflective member and a collective optics, and configured to guide a first light to the light detector, the first light being incident on the reflective member along an optical path opposite to the projected laser beam; and a first reflective area configured to specularly reflect the laser beam, at a predetermined portion partly overlapping the scanning range in the first direction.

It is conceivable that the light scanning apparatus further includes a frequency adjusting assembly configured to adjust a driving frequency to be applied to the actuator such that, regarding to a time interval between a first reference scan timing determined based on detection timing of a light reflected from the first reflective area in a scan and a second reference scan timing determined based on a timing when the scan reaches a predetermined end of the scanning range, a first value of the time interval along the forward scan path passing through the first reflective area and a second value of the time interval along the backward scan path passing through the first reflective area substantially become equal.

{0011} It is also conceivable that the first reflective area has a generally specular surface, and the specular reflective surface of the first reflective area is extended at least along the first direction to form a second reflective area and the second reflective area is smoothly continuous with the first reflective area, the second reflective area being configured to specularly reflect the projected laser beam incident thereon to a direction different to that the retrospective optics guides the reflected laser beam to the light detector.

Further, it is also conceivable that the frequency adjusting assembly uses: an anterior end of the detection timing of the light reflected from the first reflective area in the forward scan path and a posterior end of the detection timing of the light reflected from the first reflective area in the backward scan path; or a posterior end of the detection timing of the light reflected from the first reflective area in the forward scan path and an anterior end of the detection timing of the light reflected from the first reflective area in the backward scan path, as the first reference timing.

{0012} Further, it is also conceivable that the scanning assembly is configured to scan the scanning range with the laser beam in a primary scanning direction that is the first direction and in the secondary scanning direction different from the primary scanning direction, and the first reflective area is positioned only in a part of the scanning range in the secondary scanning direction such that at least a pair of reciprocating primary scanning lines pass therethrough.

Further, it is also conceivable that the light scanning apparatus further includes: a measuring assembly configured to measure time of flight (ToF) value between projection of the laser beam and reception of light by the light detector; and a determining assembly configured to determine that the projected laser beam is reflected from the first reflective area when the ToF value measured by the measuring assembly is less than a predetermined threshold. The ToF may be whichever of direct time of flight and indirect time of flight.

{0013} Further, another purpose of the present invention is to enable to easily adjust scanning angular range to a desired value in a light scanning apparatus configured to scan a predetermined scanning range (field of view) with light using an actuator periodically and reciprocally rotates a movable member. The present invention provides alternative light scanning apparatus to achieve such purpose.

The alternative light scanning apparatus includes, instead of the frequency adjusting assembly of the light scanning apparatus described above, an amplitude adjusting assembly configured to adjust a driving amplitude applied to the actuator such that detection timing at which the light detector detects the light reflected from the first reflective area within the reciprocal scan satisfies a predetermined condition.

{0014} It is conceivable that the predetermined condition is that a period in which the light detector detects a light reflected from the first reflective area or a period in which the light detector does not detect the light reflected from the first reflective area, within one scanning period, becomes a predetermined target length.

Alternatively, the predetermined condition can be that a time interval, between a first reference scan timing determined based on detection timing of a light reflected from the first reflective area in a first scan and a second reference scan timing determined based on detection timing of a light reflected from the first reflective area in a second scan subsequent to the first scan, becomes a predetermined target length.

Alternatively, the predetermined condition can be that a time interval, between a first reference scan timing determined based on detection timing of a light reflected from the first reflective area in a first scan and a second reference scan timing determined based on a timing when the first scan reaches an end of the scanning range, becomes a predetermined target length.

{0015} Further, in these light scanning apparatuses, it is conceivable that the scanning assembly is configured to scan the scanning range with the laser beam in a primary scanning direction that is the first direction and in the secondary scanning direction different from the primary scanning direction, and the first reflective area is positioned only in a part of the scanning range in the secondary scanning direction such that at least one primary scanning line passes therethrough.

{0016} Further, it is conceivable that the light scanning apparatus further includes a frequency adjusting assembly configured to adjust a driving frequency applied to the actuator such that, regarding to a time interval between a first reference scan timing determined based on detection timing of a light reflected from the first reflective area in a primary scan and a second reference scan timing determined based on a timing when the primary scan reaches a predetermined end of the scanning range, a first value of the time interval along the forward scan path passing through the first reflective area and a second value of the time interval along the backward scan path passing through the first reflective area substantially become equal, and the amplitude adjusting assembly is configured to adjust the driving amplitude in a state where the first value and the second value of the time interval are substantially equal.

With a merit of the above alternative light scanning apparatus, scanning angular range can be adjusted to a desired value in a light scanning apparatus configured to scan a predetermined scanning range with light using an actuator periodically and reciprocally rotates a movable member, and thus scanning within a desired angular range can be easily performed.

{0017} Further, an object detecting apparatus of the invention includes, in addition to any of the light scanning apparatuses described above, a measuring assembly configured to measure time of flight (ToF) value between projection of the laser beam and reception of light by the light detector; and an object detecting assembly configured to detect a distance to an object and a direction in which the object is located, based on the ToF value measured by the measuring assembly regarding to respective projections of the laser beam.

In a case where the light scanning apparatus includes the measuring assembly and the determining assembly, an object detecting apparatus can be configured by adding thereon an object detecting assembly configured to detect a distance to an object and a direction in which the object is located, based on the ToF value measured by the measuring assembly regarding to respective projections of the laser beam.

According to the object detecting apparatus, the light scanning apparatus described above can be utilized at low cost in an object detecting apparatus such as a LiDAR, and the function thereof can be exhibited.

{0018} The present invention can be embodied not only as described above, but also as any other aspect such as an apparatus, a system, a method, a computer program, or a storage medium on which a computer program is stored. Of course, the present invention can also be implemented as a light scanning apparatus configured to perform scanning with light for purposes other than object detection, a light scanning method or a computer program therefor, and the like. In this case, it is not essential to detect a direction in which an object is present and a distance to the object.

{0019} According to the present invention as described above, a light scanning device configured to scan a predetermined scanning range with light using an actuator that reciprocally rotates a movable member can be realized at low power consumption and low cost.

### BRIEF DESCRIPTION OF DRAWINGS

{0020}FIG. 1 is a block diagram illustrating principal configuration related with an embodiment of an object detecting apparatus 10 according to the present invention focusing on the functions thereof.

FIG. 2 is an illustration to explain the principle of object detection in the object detecting apparatus 10.

FIG. 3 is an exploded perspective view illustrating configurations of main constituent elements of the object detecting apparatus 10.

FIG. 4 is a perspective view illustrating an external appearance of the object detecting apparatus 10.

FIG. 5 is a view showing schematic appearance and arrangement of actuators 300, 380.

FIG. 6A to FIG. 6D are exploded perspective views showing components constituting the actuator 300 and an outline of assembly process thereof.

FIG. 7 is an exploded perspective view illustrating components constituting a movable member 320 of the actuator 300.

FIG. 8 is a cross-sectional view showing a cross section of the actuator 300 shown in FIG. 6D by a chain line as seen from an arrow M.

FIG. 9 is a view showing schematic appearance and arrangement of actuators 400, 380.

FIG. 10 is a perspective view showing structure of an actuator 400.

FIG. 11 is an exploded perspective view of the actuator 400.

FIG. 12 is an exploded perspective view of the actuator 400 in more detail than FIG. 11.

FIG. 13A to FIG. 13C are views for illustrating the principle of reciprocating rotation of the actuator 400.

FIG. 14A to FIG. 14C are other views for illustrating the principle of reciprocating rotation of the actuator 400.

FIG. 15 is a diagram showing an example of waveform of a drive signal applied to the driving coil 420 of the actuator 400.

FIG. 16 is a graph showing an example of relationship between scan angle and absolute value of angular velocity regarding to the mirror 401 of the actuator 400.

FIG. 17 is a view corresponding to FIG. 16, showing another example.

FIG. 18 is a view corresponding to FIG. 16, showing the third example.

FIG. 19 is a schematic diagram illustrating optical paths of the laser beam projected from the scanning assembly 30 and the reflected light to be detected by the light-receiving element 43 in more detail than FIG. 1.

FIG. 20 is a schematic diagram illustrating relationship between the scanning range of the outward light L2 and positions of the reflective area 66 and the effective reflective area 66a.

FIG. 21 is a diagram for explaining a method of detecting a time period during which the outward light L2 is reflected by the reflective area 66.

FIG. 22 is a diagram illustrating periods during which light reflected from the effective reflective area 66a is detected during one primary scan in the case where the scan angle and the angular velocity of the mirror 401 are in the relationship illustrated in FIG. 16.

FIG. 23 is a diagram corresponding to FIG. 22 illustrating the case where the scan angle and the angular velocity of the mirror 401 are in the relationship illustrated in FIG. 17.

FIG. 24 is a diagram corresponding to FIG. 22 illustrating the case where the scan angle and the angular velocity of the mirror 401 are in the relationship illustrated in FIG. 18.

FIG. 25 is a flowchart of a process of adjusting driving frequency executed by the processor circuitry 53.

FIG. 26 is a graph corresponding to FIG. 16, showing other examples of relationship between scan angle and absolute value of angular velocity regarding to the mirror 401 of the actuator 400.

FIG. 27 is a schematic diagram corresponding to FIG. 20, illustrating another example of relationship between the scanning range of the outward light L2 and positions of the reflective area 66 and the effective reflective area 66a.

FIG. 28 is a diagram corresponding to FIG. 22, illustrating periods during which light reflected from the effective reflective area 66a is detected during one primary scan in the respective conditions shown in FIG. 26.

FIG. 29 is a flowchart of a process of adjusting driving amplitude executed by the processor circuitry 53.

FIG. 30 is a diagram showing another example of the reference timing used in the driving amplitude adjustment.

FIG. 31 is a diagram showing still another example of the reference timing used in the driving amplitude adjustment.

FIG. 32 is a schematic diagram corresponding to FIG. 19, illustrating configuration of a comparative example of the present invention.

FIG. 33 is a diagram illustrating an example of drive signal of the LD module 21.

FIG. 34 is a diagram for explaining a method of detecting a time period during which the outward light L2 is reflected by the reflective area 66, in the case where the LD module 21 is continuously turned on.

### DESCRIPTION OF EMBODIMENTS

{0021} The embodiments of the present invention will be described with reference to the related drawings.

### 1. Overall Configuration of an Object Detecting Apparatus (FIG. 1 to FIG. 4)

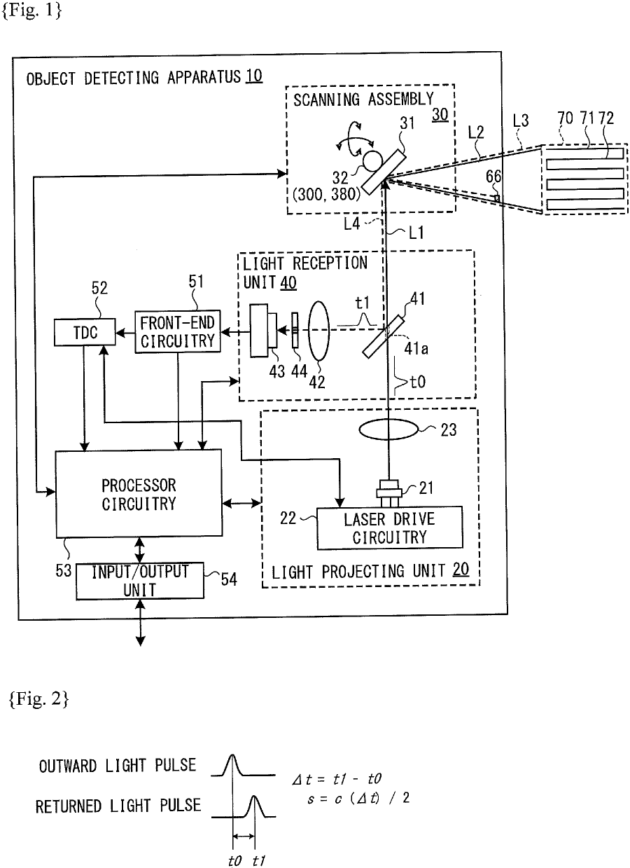

First, the overall configuration of the object detecting apparatus disclosed as an embodiment of the invention will be described in FIG. 1 and FIG. 2 with the explanation focusing on the principal configuration and their functions thereof. FIG. 1 is a block diagram illustrating the principal configuration of the object detecting apparatus focusing on the functions thereof. FIG. 2 is an illustration to explain the principle of the object detection in the object detecting apparatus.

{0022} The object detecting apparatus 10 according to an embodiment of the present invention is configured to: project a laser beam outward, detect the laser beam reflected by an external object and thereafter returned back to the object detecting apparatus 10, and thereby detect a distance to the object located along the optical path of the laser beam and the direction of the object based on the time difference between the projection timing of the laser beam and the detection time of the reflected light. As shown in FIG. 1, the object detecting apparatus 10 includes a light projecting unit 20, a scanning assembly 30, a light reception unit 40, a front-end circuitry 51, a Time-to-Digital Converter (TDC) circuitry 52, a processor circuitry 53, and an input/output unit 54.

{0023} The light projecting unit 20 is configured to project a laser beam outward, and includes an LD (laser diode) module 21, a laser drive circuitry

The LD module 21 is a laser light source that outputs laser light according to a drive signal applied from the laser drive circuitry 22. Herein, a light source having a plurality of light emitting points is used to improve the output intensity, but the number of light emitting points may also be single. The wavelength of the laser is not particularly limited. For example, near-infrared light is preferred. The laser light is an example of a light beam.

The laser drive circuitry 22 is configured to generate a drive signal for lighting the LD module 21 at a specific timing, based on a parameter supplied from the processor circuitry 53 and apply the drive signal to the LD module 21. The LD module 21 is intermittently lighted by a pulse signal waveform.

{0024} The collimating optical assembly 23 is configured to transform the laser light output by the LD module 21 into a general collimated light beam. In this embodiment, a collimator lens composed of a convex lens is used, and the focal point of the convex lens is aligned to the center position of the plurality of light emitting points of the LD module 21.

In addition, the laser beam L1 formed by the collimating optical assembly 23 passes through a light transmitting area 41a of a mirror 41 of the light reception unit 40, is reflected by a mirror 31 of the scanning assembly 30, and transmits outward as the outward light L2.

{0025} The scanning assembly 30 is configured to deflect the laser beam projected by the light projecting unit 20 to scan within a specified field of view (FOV) 70, and includes an actuator 32 with the mirror 31 which is a reflective member. The actuator 32 periodically changes the deflecting direction of the projected light by periodically changing the direction of the mirror 31 located on the optical path of the laser beam.

{0026} In addition, although only one actuator 32 is shown in FIG. 1, as shown in FIG. 5, the actuator 32 includes two actuators 300, 380 that actuate the mirror to oscillate around different axes, respectively. The actuator 300 reciprocally drive a mirror to form primary scanning (Horizontal) lines 71, 72, and the actuator 380 changes the orientation of the mirror at the end of the primary scanning line to adjust the scanning position in the secondary scanning direction. Here, the scanning line 71 scans from left to right and the scanning line 72 scans from right to left in the figure. Here the former is called forward scan path, and the latter is called backward scan path. However, these names are for simply discriminating these two scan paths, and thus the forward scan and the backward scan may be reversed.

{0027} Since the LD module 21 is intermittently fired, the scanning lines 71, 72 are actually not continuous lines but a series of discrete beam spots.

Further, a reflective area 66 is provided on the optical path of the outward light L2. The reflective area 66 is an area configured to reflect at least a part of the outward light L2 toward the optical path along which the outward light L2 is incident on the reflective area 66, at a predetermined position that is a part of the primary scanning range. The reflective area 66 will be described later in detail.

The light projecting unit 20 and the scanning assembly 30 constitute a light scanning apparatus.

{0028} The light reception unit 40 is configured to detect light incident from the external of the object detecting apparatus 10, and includes the mirror 41, a collective lens 42, a light-receiving element 43, and an aperture 44. The light to be detected by the light reception unit 40 is supposed only those reflected light of the laser beam projected from the object detecting apparatus 10 and thus reflected and returned back to the object detecting apparatus 10, the reflected light including both the light reflected by an external object and the light reflected by the reflective area 66. The laser beam reflected by the external object is scattered on the surface thereof, and only the angular portion reflected in a direction opposite to the optical path when the light is projected is returned back to the object detecting apparatus 10 as returned light L3. The returned light L3 returns back along the retroreflective direction which is substantially the same but the reverse path to the outward light L2 and reaches the mirror 41 as the returned light L4.

{0029} Similarly, a part of the laser beam reflected by the reflective area 66 in a direction opposite to the optical path when the light is projected is retrospectively returned back to the mirror 41 as the returned light L4. The difference from the case of being reflected by an external object is essentially only in the travel distance of the laser beam. Note that since the reflective area 66 is closer than the external object, another part of the laser beam reflected by the reflective area 66 in a direction different from the incident light path of the outward light L2 also reaches the mirror 41. However, the part reflected in the direction different from the outward light L2 is blocked by the aperture 44, and substantially only the part reflected toward the incident light path of the outward light L2 reaches the light-receiving element 43.

{0030} The mirror 41 is a fixed mirror including a light transmitting area 41a through which the laser beam projected by the light projecting unit 20 passes, and the mirror 41 is configured to guide the returned light L4 to the light-receiving element 43. Here, the laser beam output from the LD module 21 generally does not become a perfectly collimated beam even after passing through the collimating lens, but has a small divergence angle. Hence, at the position of the mirror 41, the returned light L4 is occupying much wider area than the laser beam L1, therefore the returned light is incident on an area wider than the light transmitting area 41a on the mirror 41, and the portion of the returned light L4 incident on the area other than the light transmitting area 41a is reflected toward the light-receiving element 43.

{0031} The collective lens 42 collects the returned light L4 reflected by the mirror 41 and forms an image of such incident light on a specific focal plane.

The light-receiving element 43 is a light detecting element that outputs a detection signal corresponding to the intensity of light falling on its light-receiving surface. In this embodiment, a silicon photomultiplier (SiPM) is used as the light-receiving element 43. This will be described in detail later. {0032} The aperture 44 is arranged on the focal plane of the collective lens 42, and blocks light falling on the area out of an opening area thereof to prevent unwanted light from entering the light-receiving element 43. More specifically, the aperture 44 allows a part of the returned light L4 which is retrospectively incident on the mirror 41 in a direction opposite to the optical path when the light is projected and reflected by the mirror 41 to pass therethrough with a predetermined diameter, and blocks the other light. Therefore, even if a portion of the laser beam reflected by the reflective area 66 in a direction different from the incident light path of the outward light L2 reaches the mirror 41, the portion is blocked by the aperture 44 and does not reach the light-receiving element 43.

The mirror 41, the collective lens 42, and the aperture 44 constitute a light receiving optical assembly. Further, the light-receiving optical assembly and the mirror 31 correspond to a retrospective optics.

{0033} The front-end circuitry 51 is configured to shape the detection signal output by the light-receiving element 43 into a waveform preferred for timing detection in TDC circuitry 52.

The TDC circuitry 52 is a circuitry configured to form, based on the drive signal provided by the laser drive circuitry 22 and the shaped detection signal provided by the front-end circuitry 51, a digital output representing a time difference between timing t0 of firing pulse of the laser beam L1 to be projected and timing t1 of pulse of the corresponding returned light L4. The TDC circuitry 52 functions as a measuring assembly to measure a time of flight (Tof) value that is a time difference between projection of the laser beam and detection by the light-receiving element 43.

{0034} Between a pulse of the projected light and a pulse of the returned light, the time delay occurs when the projected light reaches the object along the optical path and returns to the object detecting apparatus 10. Thus, based on the time delay Δt, the distance s from the object detecting apparatus 10 to the object can be calculated according to s = c(Δt)/2, as shown in FIG. 2, where c is the velocity of light.

In more accurate meaning, s is the length of an optical path from the object to the light-receiving element 43. In the case where the laser beam is reflected back by the reflective area 66, s means basically the length of the optical path from the reflective area 66 to the light-receiving element 43. However, if the distance from the LD module 21 to the mirror 41 and the distance from the mirror 41 to the light-receiving element 43 differ largely, it is preferable to appropriately correct an error due to the distance difference.

{0035} The processor circuitry 53 is configured to control the operations of configurations illustrated in FIG. 1. The processor circuitry 53 may be constructed by a general-purpose computer including a CPU, a ROM, a RAM, or the like and executing software, or by dedicated hardware, or by a combination thereof. For example, the processor circuitry 53 calculates the distance to the object based on the output signal of the TDC circuitry 52, and calculates the direction of the object based on the scanning timing of the scanning assembly 30 (the deflecting direction of the outward light L2) at the detection timing of the returned light. The calculated distance and direction may be related with each other.

Alternatively, the processor circuitry 53 may calculate distance to the object corresponding to some projections of the outward light L2. For example, the processor circuitry 53 may calculate distance to the object based on the output signal of the TDC circuitry 52 only, and information of the direction is not included in the output signal. However, the output signal can be corresponded to the information of the position of the detected spot, that is, what number of spot in what number of primary scanning line. Since position of a particular spot can be corresponded to the direction of the outward light L2 that forms the particular spot, the calculated distance can be corresponded to the direction, even if the direction itself is not detected for each time. Even in this case, the processor circuitry 53 is configured to detect a distance to an object related to direction of each projection of the laser beam, based on the ToF value measured by the TDC circuitry 52 regarding to each projection of the outward light L2.

As described in detail later, the processor circuitry 53 also controls drive signals of the actuators 300, 380 based on the outputs by the TDC circuitry 52.

{0036} The input/output unit 54 is configured to input and output information from/to peripherals. The input and output of information here includes wired or wireless communication with peripheral apparatus, receipt of user operations with buttons, touch panels, or the like, and indication to users with displays, lamps, buzzers, vibrators, or the like. The information output from the input/output unit 54 may be information related to the detected object (for example, raw data of the distance and/or direction, or information indicating detection of an object having a specified size, position, moving speed and the like obtained based on the raw data), or information related to the operation state or setting status of the object detecting apparatus 10. The information input by the input/output unit 54 may be, for example, information related to the operation setting of the object detecting apparatus 10.

{0037} The input/output unit 54 may communicate with, for example, a vehicle with an autonomous driving system, a mobility object such as a drone device, a wearable device used with an augmented reality (AR) technology, or the like. If the information of the object detected by the object detecting apparatus 10 is provided to the autonomous driving system, the autonomous driving system can plan a driving route with reference to the information to avoid the detected object. If the information of the object detected by the object detecting apparatus 10 is provided to the wearable device, positions of surrounding objects can be detected with higher accuracy as compared with a case where the surrounding objects are estimated based on images captured by a camera, and thus artificially processed information can be fused to the object image with higher accuracy.

{0038} The present invention may also be implemented as a system including the object detecting apparatus 10 and its communication counterpart such as a vehicle, a drone, an airplane, or a wearable device. The embodiment described here is particularly useful when the object detecting apparatus 10 is mounted on a wearable device in which downsizing and low power consumption is highly demanded.

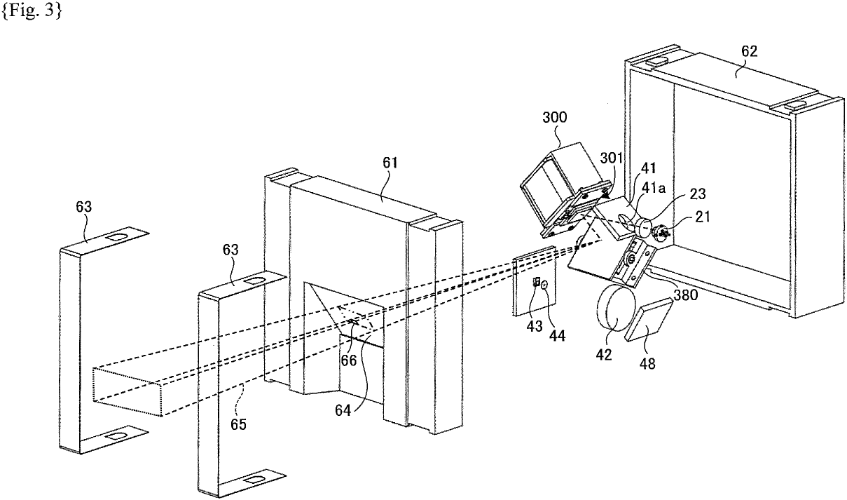

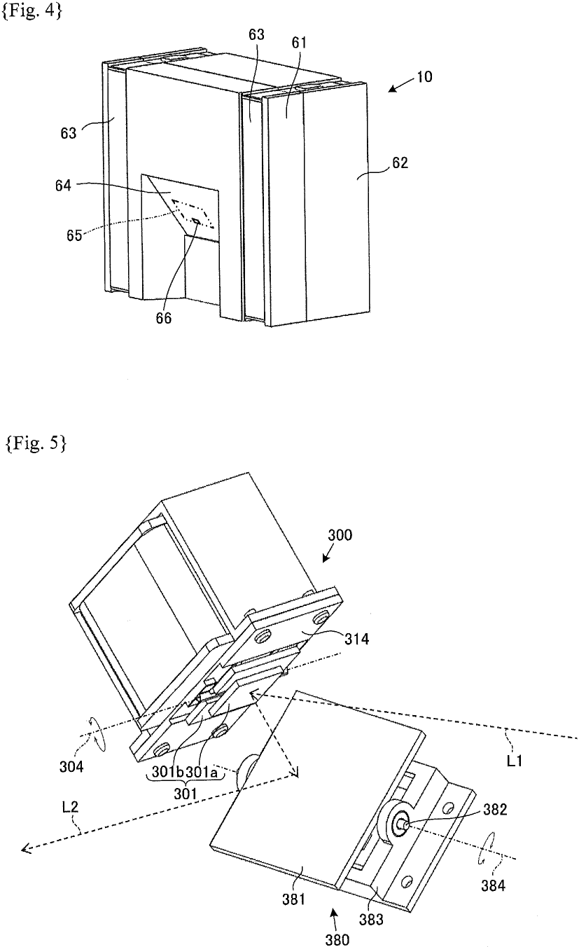

{0039} The outline of structure of the object detecting apparatus 10 will be described with reference to FIG. 3 and FIG. 4. FIG. 3 is an exploded perspective view of main constituent elements of the object detecting apparatus, and FIG. 4 is a perspective view illustrating an external appearance of the object detecting apparatus.

As shown in FIG. 3 and FIG. 4, the object detecting apparatus 10 has a housing formed of a top cover 61 and a rear cover 62 coupled through two cover clips 63, 63. The top cover 61 has a window for allowing the outward light L2 to pass through, and a protective material 64 that prevents dust from intruding into the object detecting apparatus 10 and is transparent to the wavelength of the outward light L2 is embedded into the window. The reflective area 66 is provided on the inner surface of the protective material 64.

{0040} The respective constituent elements shown in FIG. 1 are contained inside the housing. In addition, the actuator 32 shown in FIG. 1 is shown as two actuators of an actuator 300 for scanning in the primary scanning direction and an actuator 380 for scanning in the secondary scanning direction. The mirror unit 301 is provided in the actuator 300.

The mirror 48, not shown in FIG. 1, is an optical element between the mirror 41 and the collective lens 42 for changing the orientation of the returned light L4. Dotted lines 65 indicate the field of view of the object detecting apparatus 10 (the scanning range of the outward light L2), corresponding to the field of view 70 in FIG. 1. The circuits such as the laser drive circuitry 22, the processor circuitry 53, and the like, and the wires between mentioned assembly/units are omitted in FIG. 3 to simplify the drawing.

Described above is the overall structure. Hereinafter, several constituent elements of the object detecting apparatus 10 will be described, respectively.

### 2. Scanning Assembly 30 and Actuator 300 (FIG. 5 to FIG. 8)

{0041} It has been described that the scanning assembly 30 includes actuators 300 and 380. The actuator 300 among these will be described at first.

FIG. 5 shows enlarged appearance and arrangement of the actuators 300, 380 in FIG. 3.

{0042} As shown in FIG. 5, the structures of the actuator 300 and the actuator 380 are substantially different.

The actuator 380 is used for deflecting the outward light L2 in the secondary scanning direction, so high-speed motion is not required, and an actuator that rotates the mirror around the physical axis is available. The actuator 380 is configured in such a way that a mirror 381 is fixed to a shaft 382 and the shaft 382 is inserted into a holder 383 such that the shaft 382 is rotatably attached to the holder 383. By the magnetic interaction of the permanent magnet attached to the rear side of the mirror 381 and a static coil (not shown), the mirror 381 rotates around the rotation axis 384 at the center of the shaft 382, and performs reciprocal scanning within a specified angle range corresponding to the voltage applied to the coil. The motion of the mirror may also be halted at a specific angle within the scanning range by adjusting the strength of the voltage.

{0043} This type of actuator can be classified as a galvanometer mirror. Generally, such structure in which a mirror mounted at one end of the shaft is rotated by applying a force to the other end of the shaft is widely used. However, like the actuator 380, even if the force is applied to the shaft at the same longitudinal section as the mounting position of the mirror, the actuator can also be driven based on the same principle.

{0044} On the other hand, since the actuator 300 is used for deflecting the outward light L2 in the primary scanning direction, high-speed motion is required, and durability for sustaining the high-speed motion for a long time is also required. Therefore, an actuator that meets such purposes is adopted as the actuator 300.

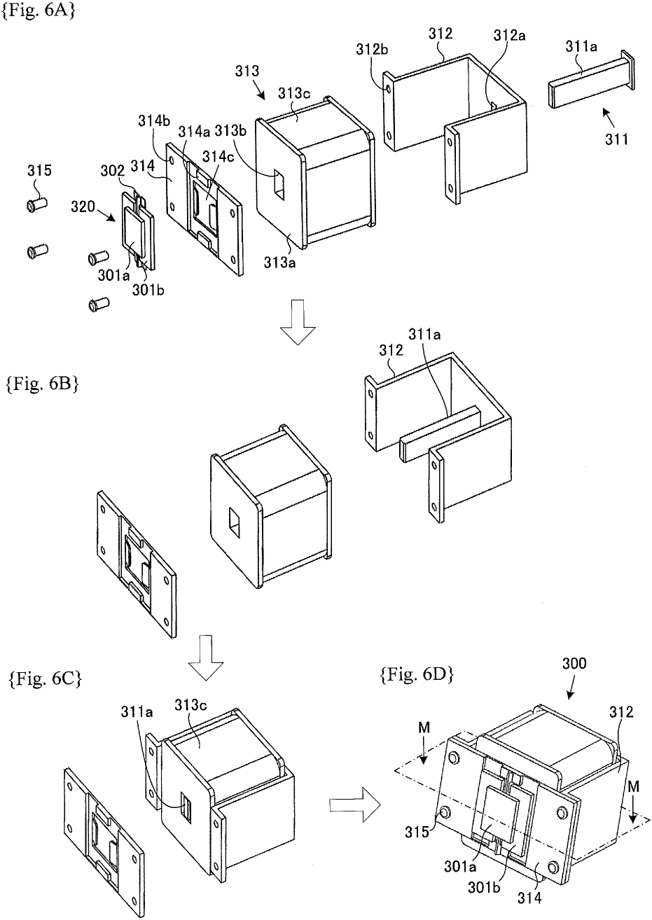

{0045} The specific structure of the actuator 300 will be described in detail with reference to FIG. 6A to FIG. 8. As an outline explanation, the actuator 300 is configured such that the mirror unit 301 is fixed to a first side of the torsion spring 302 with a straight folded peak where the mirror unit 301 is implemented across the folded peak, and the ends of the torsion spring 302 are fixed to a top yoke 314 as a support member. By magnetic interaction between the permanent magnet coupled to a second side of the torsion spring 302 and a static coil, the torsion spring 302 and the mirror unit 301 rotate around a rotation axis 304 approximately located at the center of the folded peak of the torsion spring 302, and reciprocally scan within a specified angle range corresponding to the voltage applied to the coil.

{0046} The scanning assembly 30 reflects and deflects the laser beam L1 through the mirror unit 301 and the mirror 381 driven by the actuators 300 and 380 respectively, thereby projecting the outward light L2 outward along the scanning lines 71 and 72 shown in FIG. 1.

Note that an actuator having the same structure as the actuator 300 may be adopted as an actuator for scanning in the secondary scanning direction.

{0047} The structure and operation principle of the actuator 300 will be described in more detail with reference to FIG. 6A to FIG. 8.

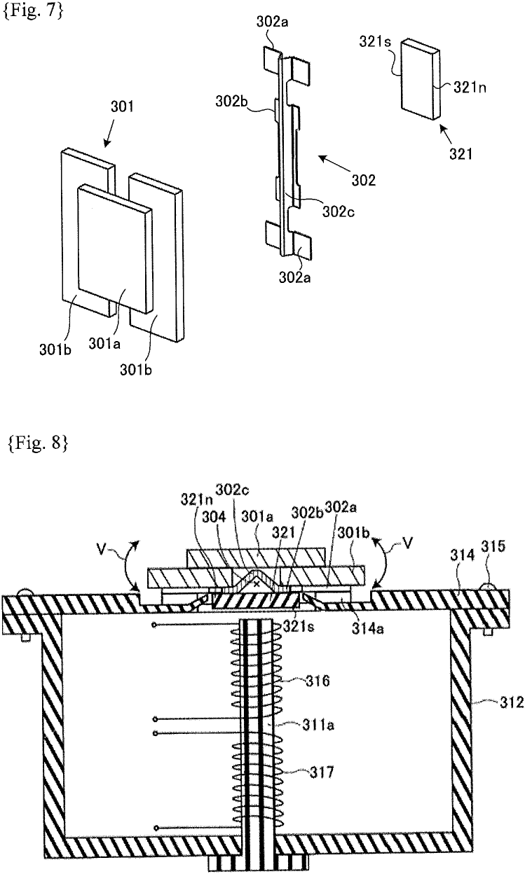

FIG. 6A to FIG. 6D are exploded perspective views showing components constituting the actuator 300 and an outline of assembly process thereof, and FIG. 6D is also a perspective view of the actuator 300 completed in the final process. FIG. 7 is an exploded perspective view illustrating components constituting a movable member 320 of the actuator 300. FIG. 8 is a cross-sectional view showing a cross section of the actuator 300 shown in FIG. 6D (a cross section with a plane that passes through the vicinity of the center of planar arms 302b and is perpendicular to the longitudinal direction of a folded peak 302c) as seen from an arrow M. To simplify the drawing, a coil assembly 313 is omitted and a winding structure of the coil is schematically shown in FIG. 8.

{0048} As shown in FIG. 6A, the actuator 300 includes a core yoke 311, a frame yoke 312, a coil assembly 313, a top yoke 314, and the movable member 320.

The frame yoke 312 and the top yoke 314 are made of magnetic substance and form a wall structure surrounding the coil. The frame yoke 312 and the top yoke 314 are fixed with each other by four screws 315 penetrating four pairs of screw holes 312b, 314b to hold the coil assembly 313 inside.

{0049} The coil assembly 313 includes a driving coil 316 and a sensing coil 317 wound around a non-magnetic bobbin 313a as shown in FIG. 8, and is covered with a protective cover 313c. A through hole 313b which allow the core section 311a of the core yoke 311 passing through is formed in the center section of the bobbin 313a. The protective cover 313c is provided with a terminal for applying a drive signal to the driving coil 316 and a terminal for outputting a signal generated in the sensing coil 317 at a position not interfere with the magnetic wall.

The core yoke 311 includes a core section 311a made of a ferromagnetic body that serves as a core of the driving coil 316 and the sensing coil 317.

{0050} The core section 311a of the core yoke 311 is inserted into a corresponding hole 312a of the frame yoke 312 as shown in FIG. 6B, then the core section 311a is inserted into the through hole 313b of the coil assembly 313 to position the coil assembly 313 as shown in FIG. 6C, and the top yoke 314 and the frame yoke 312 are fixed with each other by the screws 315 as shown in FIG. 6D.

{0051} The core section 311a is fixed to the frame yoke 312 in the steps of FIG. 6A to FIG. 6B, and the coil assembly 313 is fixed to the core section 311a (and the frame yoke 312) in the steps of FIG. 6B to FIG. 6C. It is also preferred to perform these assembly process by other types of screw not mentioned above, or by welding or bonding process, or by press fit process where a member inserted is slightly larger than a space on a reception side, or by a combination with these manufacture processes.

In FIG. 6B and FIG. 6C, the movable member 320 is omitted to save the drawing space.

{0052} As shown in FIG. 7, the movable member 320 includes a permanent magnet 321 in addition to the mirror unit 301 and the torsion spring 302.

The torsion spring 302 is formed by folding a metal plate by press manufacture, bending manufacture, or the like. The torsion spring 302 is in a folded shape with a straight folded peak 302c with a V-shaped cross section. Planar arms 302b respectively protruding to both sides so as to be across the folded peak 302c are formed near the longitudinal middle section of the folded peak 302c, and planar arms 302a respectively protruding to both sides so as to be across the folded peak 302c are formed at both longitudinal ends of the folded peak 302c respectively. The folded peak 302c and the planar arms 302a and 302b are composed as a unity. By forming those portions by bending a single metal plate, the torsion spring 302 with sufficient strength at low manufacturing cost can be realized.

{0053} All of the planar arms 302a at both longitudinal ends and the planar arms 302b are on the same plane in the natural state. However, when a force of rotating around the folded peak 302c is applied to the planar arms 302b while the planar arms 302a at both longitudinal ends are fixed on the same plane, the folded peak 302c is twisted, and the planar arms 302b are rotated around the folded peak 302c. When the application of the force is stopped, the torsion of the folded peak 302c is released by the restoring force of the spring, and the planar arms 302b returns to the same plane as the planar arms 302a.

The permanent magnet 321 is fixed to a side of the planar arms 302b opposite to the folded peak 302c so that its N-pole 321n and S-pole 321s are located at the separated sides across the folded peak 302c. The positions of the N-pole 321n and the S-pole 321s may also be opposite to the figure. The permanent magnet 321 may be fixed to the planar arms 302b by any method such as bonding or welding.

{0054} As shown in FIG. 7, the mirror unit 301 is formed by partially overlapping and bonding a first mirror 301a and two second mirrors 301b. The mirror unit is furtherly fixed to the torsion spring 302 by bonding the two second mirrors 301b to the planar arms 302b respectively on the surfaces towards the folded peak 302c. An adhesive may be adopted for the bonding, but the type with lower curing shrinkage is preferred.

{0055} As shown in FIG. 8, the first mirror 301a does not contact with the top of the folded peak 302c, and there is a small gap between them. That is, the first mirror 301a is coupled only to the second mirrors 301b, and the second mirrors 301b serve as spacers. Since the folded peak 302c is slightly deformed when the torsion spring 302 is twisted, a certain space is preferably to ensure the folded peak 302c not interfering with surrounding components even if the deformation occurs.

{0056} The movable member 320 is furtherly fixed to a movable member support part 314a of the top yoke 314 in a step illustrated between FIG. 6C and FIG. 6D. The components shown in FIG. 7 are assembled together in advance. The fixation may be performed by any method. For example, the planar arms 302a may be fixed to the movable member support part 314a by screws (not shown), or the planar arms 302a may be bonded or welded to the movable member support part 314a, or the planar arms 302a may be respectively inserted into slits formed in the movable member support part 314a.

{0057} In a state where the movable member 320 is fixed to the top yoke 314, the planar arms 302b of the torsion spring 302 and the permanent magnet 321 are opposed to the coil assembly 313 through an opening 314c of the top yoke 314. More specifically, as shown in FIG. 8, one end of the axis of the driving coil 316 disposed in the coil assembly 313 faces the midpoint among the N-pole 321n and the S-pole 321s of the permanent magnet 321. The driving coil 316 is disposed on a side opposite to the torsion spring 302 as viewed from the permanent magnet 321.

{0058} When the driving coil 316 is powered on in this state, for example, when the end facing the permanent magnet 321 becomes an N-pole, the S-pole 321s of the permanent magnet 321 is pulled close to the driving coil 316, the N-pole 321n is pushed away from the driving coil 316. Therefore the force interacting with the permanent magnet 321 shall be the clockwise direction if seen in the cross-sectional view of FIG. 8. This force is also applied to the planar arms 302b of the torsion spring 302, and the torsion spring 302 is rotated and twisted clockwise around the virtual rotation axis 304 near the center of the cross section of the folded peak 302c. Thereby, the mirror unit 301 coupled to the planar arms 302b also rotates clockwise around the rotation axis 304.

The rotation is stopped at a position where the magnetic force generated between the driving coil 316 and the permanent magnet 321 is balanced with the restoring force of the torsion spring 302. The speed and stop position of the rotation can be adjusted by changing the intensity of current applied to the driving coil 316.

{0059} After the permanent magnet 321 and the mirror unit 301 rotate clockwise to an appropriate position, when the direction of current applied to the driving coil 316 is reversed, the end facing the permanent magnet 321 becomes an S-pole, the N-pole 321n of the permanent magnet 321 is pulled close to the driving coil 316, the S-pole 321s is pushed away from the driving coil 316. Therefore, the force interacting with the permanent magnet 321 shall be the counterclockwise direction if seen in the cross-sectional view of FIG. 8. This force is also applied to the planar arms 302b of the torsion spring 302 in the same manner as in the case of the clockwise direction, and the torsion spring 302 is rotated counterclockwise around the rotation axis 304 and twisted in the opposite direction. Thereby, the mirror unit 301 coupled to the planar arms 302b also rotates counterclockwise around the rotation axis 304.

{0060} By reciprocally changing the direction of voltage or current of the drive signal applied to the driving coil 316, as shown by arrows V in FIG. 8, the mirror unit 301 performs the rotation in the clockwise and counterclockwise direction reciprocally within a certain angular range around the rotation axis 304. That is, the mirror unit 301 can be oscillated along a predetermined moving path. Accordingly, periodical deflection of the laser beam L1 required for scanning in the primary scanning direction as described in FIG. 1 can be realized.

{0061} In consideration of the lifespan of the torsion spring 302, the oscillation is preferably symmetrical with respect to the natural state. But this is not essential. For example, the oscillation can also be performed within an angular range with one end thereof at a position near the natural state by periodically turning on and off the voltage applied to the driving coil 316. The mirror unit 301 can be oscillated within an arbitrary angular range by periodically changing the voltage or current applied to the driving coil 316 within an appropriate range, as long as the angular range is in the rotatable limit of the torsion spring 302.

{0062} High-speed scanning with low power consumption can be achieved by driving the actuator 300 above at or near the resonant frequency of the movable member 320.

In the actuator 300, the end portions of the movable member 320 are fixed to the top yoke 314 respectively, but the portion near the actually moving planar arms 302b floats in the air. Accordingly, no friction between the components occurs during the oscillation, and thus even if the actuator 300 is continuously driven for a long time, heat or wear is generally not produced. Therefore, high durability can be obtained.

Since the coil assembly 313 is surrounded by the magnetic top yoke 314 and frame yoke 312, leakage of magnetic force generated in the driving coil 316 can be prevented, and high driving efficiency can be obtained. However, such a magnetic wall structure to house the coil assembly 313 is not essential.

{0063} The material of the torsion spring 302 may be, for example, stainless steel or phosphor bronze. Besides, any material that can form an elastic spring may be used. It is discovered by simulation by the inventor that a larger spring constant can be obtained and the resonant frequency of the torsion spring 302 can be improved through the V-shaped cross section of the folded peak 302c. Accordingly, the folded peak 302c with the V-shaped cross section is adopted in this embodiment.

However, the cross section is not limited to the V-shape. Other shapes such as n-shape, U-shape, or M-shape, W-shape, or a hollow structure with a thin wall without an opening boundary is also preferred, as long as the specific shape allows the torsion spring to function.

{0064} The structure with the straight folded peak 302c can improve the rigidity in the direction orthogonal to the rotation axis as compared with the torsion spring of a planar structure. The enhancement of the rigidity is very useful to a stable scanning in an environment where vibration always occurs, for example, on a vehicle, and also to guarantee durability of the swing structure.

The torsion spring with the folded peak 302c is three-dimensional structure and is relatively thick as an entity. Therefore, the torsion spring is easily manufactured simply by folding a planar substrate. On the other hand, it is difficult to form a torsion spring of a folded peak 302c with an enough height by wafer deposition through MEMS (Micro Electro Mechanical Systems) process.

{0065} The driving coil 316 is disposed in a direction perpendicular to the planar arms 302b in natural state in the example of FIG. 8. However, the direction is not limited to that in FIG. 8 as long as one end of the axis thereof is opposed to the midpoint among the N-pole 321n and the S-pole 321s of the permanent magnet 321. For example, even if the axis is parallel to the folded peak 302c, oscillation of the mirror unit 301 can be also realized similarly to the configuration of FIG. 8.

{0066} It is not essential that the driving coil 316 is housed in the coil assembly 313 or wound on the bobbin. The driving coil 316 may also be directly wound on the core section 311a.

Further, the sensing coil 317 is provided to perform control of the pulse interval of the LD module 21 in accordance with the direction of the mirror 31 in the scanning assembly 30 as described in PTL2, and is not required if the control is not performed.

{0067} The permanent magnet 321 may also be replaced with an electric magnet that is powered on when the mirror is driven. However, the permanent magnet 321 is preferable in merit of simple structure, small assembly error, and lower noise.

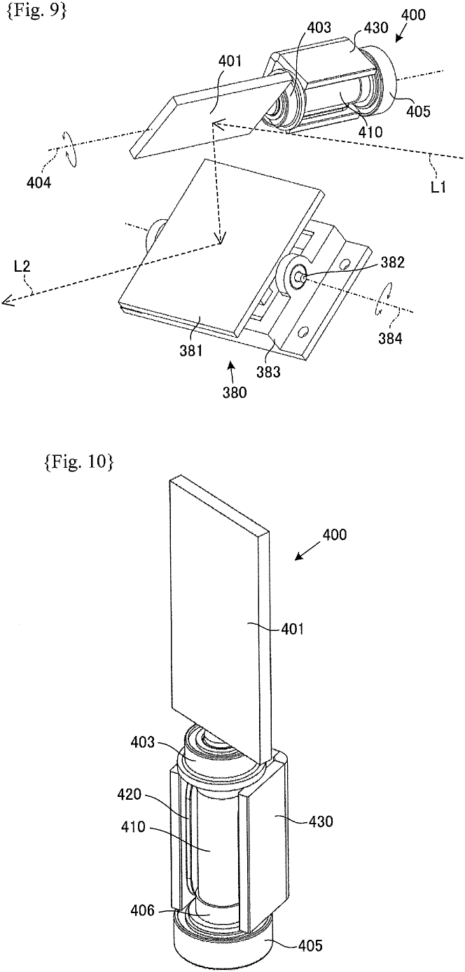

### 3. Another Structural Embodiment of Actuator (FIG. 9 to FIG. 14)

{0068} The actuator 300 adopted in the scanning assembly 30 in the above described embodiment may be substituted with another actuator where the operating principle is completely different from the actuator 300. The actuator 400 will be described as an example of said alternative actuators.

FIG. 9 shows a schematic appearance and arrangement of the actuators 400 and 380 as illustrated in FIG. 5 while only substituting the actuator 300 to the actuator 400.

{0069} Briefly, the actuator 400 is constructed such that a mirror 401 is fixed to a permanent magnet 410 and the permanent magnet 410 is held by bearings 403, 405. A soft magnetic material as a yoke 430 is disposed around the permanent magnet 410, and a driving coil 420 (see FIG. 10) is disposed between the permanent magnet 410 and the yoke 430. When the current is applied to the driving coil 420, with the magnetic interaction among the permanent magnet 410, the yoke 430 and the current flowing in the driving coil 420, both the permanent magnet 410 and the mirror 401 can reciprocally rotate as one unit within a specific angular range around a rotation axis 404 which is passing through the center of the permanent magnet 410.

{0070} The scanning assembly 30 reflects and deflects the laser beam L1 by the mirror 401 driven by the actuator 400 and the mirror 381 driven by the same actuator 380 as that shown in FIG. 5, and thus projects the outward light L2 outward along the scanning lines 71, 72 shown in FIG. 1.

Note that the actuator 300 or an actuator with the same structure as the actuator 400 may be adopted as an actuator for scanning in the secondary scanning direction.

{0071} The structure of the actuator 400 will be described in more detail with reference to FIG. 10 to FIG. 12.

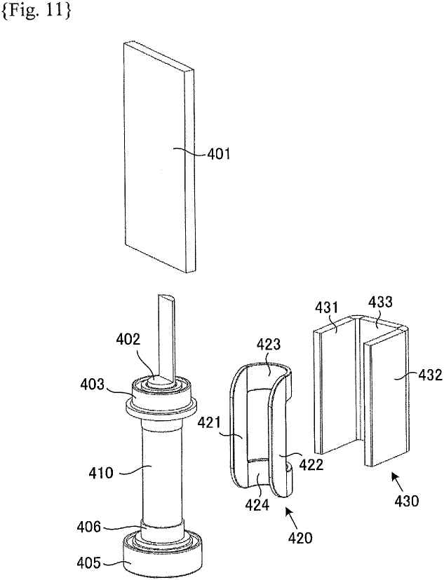

FIG. 10 is a perspective view of the actuator 400. FIG. 11 and FIG. 12 are exploded perspective views of the actuator 400, respectively. FIG. 12 shows a state where the components around the permanent magnet 410 are in the exploded view compared with FIG. 11.

As shown in FIG. 10 to FIG. 12, the actuator 400 includes the mirror 401, a mirror holder 402, the bearing 403, the bearing 405, a magnet holder 406, the permanent magnet 410, the driving coil 420, and the yoke 430.

{0072} The mirror 401 is a planar mirror with a reflecting surface for reflecting the laser beam L1 and the returned light L3.

The mirror holder 402 fixes the mirror 401 to the bearing 403 so as to rotate with the movement of the permanent magnet 410 and makes the centroid of mass of the mirror 401 located on the central axis (rotation axis) of the permanent magnet 410.

{0073} In the example of FIG. 11, the upper end of the cylindrical permanent magnet 410 is pressed into a thin-walled portion 402b to insert the permanent magnet 410 therein, whereby the mirror holder 402 is fixed to the permanent magnet 410. Thereafter, a mirror holding portion 402a is inserted through an inner ring 403a of the bearing 403 from the lower side to the upper side as illustrated in the figure and then pressed into the inner ring 403a, and thereby the mirror holder 402 is embedded and fixed to the inner ring 403a. The mirror 401 is bonded to the mirror holding portion 402a.

{0074} The bearing 403 and the bearing 405 hold the permanent magnet 410 respectively to rotate around its central axis.

The permanent magnet 410 is fixed to the bearing 403 via the mirror holder 402 in the same way as described above. The permanent magnet 410 is fixed to the bearing 405 by pressing an end thereof to a magnet holding portion 406a of the magnet holder 406 formed to embed the permanent magnet 410 therein, whereby the permanent magnet 410 is integrated with the magnet folder 406, and then pressing a bearing connecting portion 406b of the magnet holder 406 into an inner ring 405a of the bearing 405.

As described above, the permanent magnet 410 and the mirror 401 are integrally held by the bearings 403, 405 to be rotatable together with the inner ring 403a and the inner ring 405a.

{0075} The driving coil 420 is fixed to the inner side of the yoke 430 by bonding, welding, or the like, and the yoke 430 is fixed to the bearing 403 and the bearing 405 respectively by bonding, welding, or the like such that the yoke 430 does not hinder rotation of the inner rings 403a and 405a.

The fixing methods such as embedding, bonding, and welding described above are only examples, and other methods may be adopted if needed.

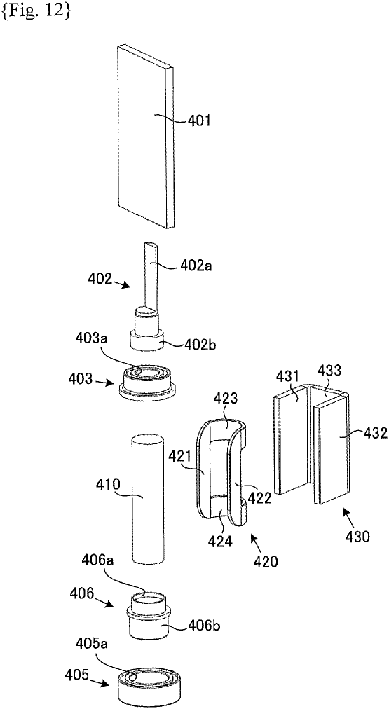

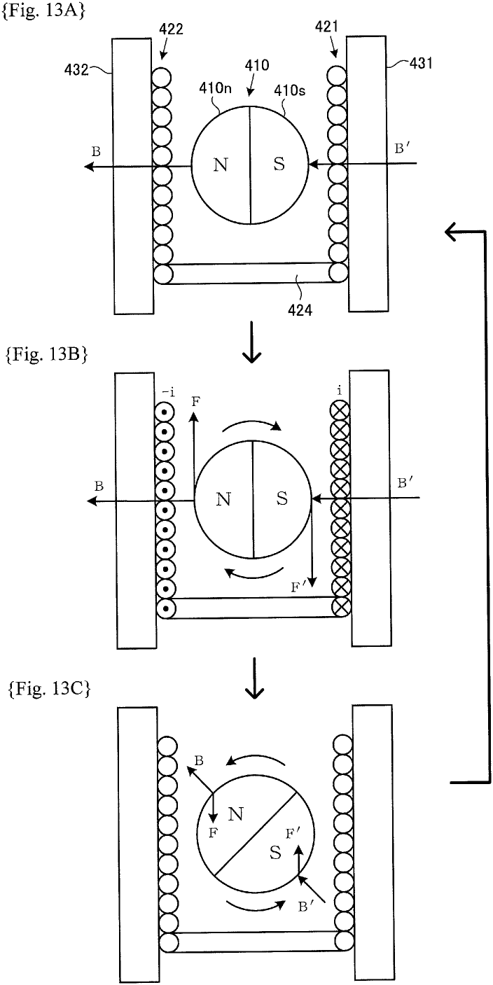

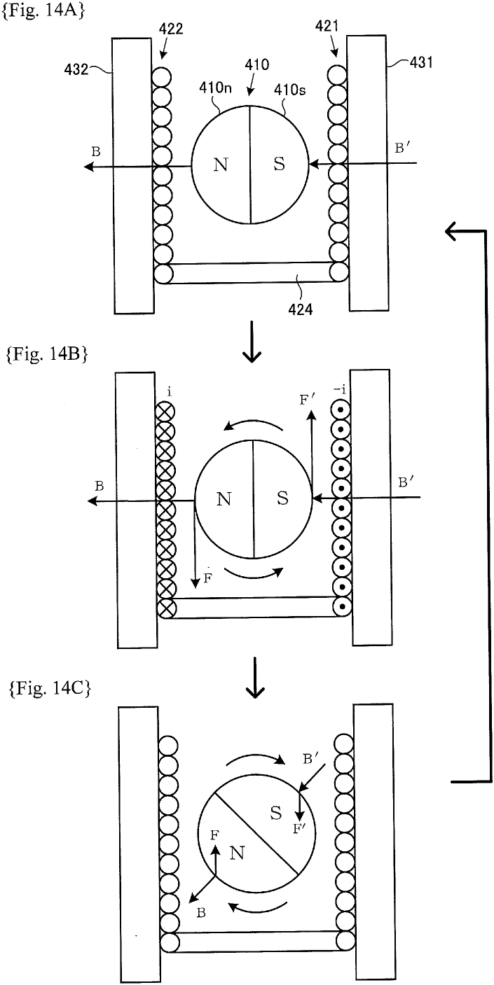

{0076} In the actuator 400, the permanent magnet 410 is cylindrical, and assuming that the cylinder is divided into two areas by a plane including the central axis thereof, an N-pole 410n thereof is located in one area, and an S-pole 410s thereof is located in the other area (refer to FIG. 13 and FIG. 14). The N-pole and the S-pole are not at the two longitudinal ends.

{0077} The driving coil 420 is provided with a first portion 421 including a wire bundle generally parallel to (the central axis of) the permanent magnet 410 and a second portion 422 which includes a wire bundle generally parallel to the permanent magnet 410. Current flows in opposite directions in the first portion 421 and the second portion 422 when powered on. The two portions 421, 422 are located on opposite sides of the permanent magnet 410. The first portion 421 and the second portion 422 are connected with each other through a first connecting portion 423 and a second connecting portion 424. The first connecting portion 423 and the second connecting portion 424 are respectively wound near the longitudinal ends of the permanent magnet 410 along the surface of the permanent magnet 410.

{0078} As shown in FIG. 10, one turn of the driving coil 420 is, for example, ascending in the first portion 421 from bottom to top along the permanent magnet 410, entering the first connecting portion 423 near the upper end of the permanent magnet 410, wound clockwise along the surface of the permanent magnet 410 as viewed from the upper side in FIG. 10, then entering the second portion 422, descending in the second portion 422 from top to bottom along the permanent magnet 410, entering the second connecting portion 424 near the lower end of the permanent magnet 410, wound counterclockwise along the surface of the permanent magnet 410 as viewed from the upper side in FIG. 10, and connected to the first portion 421 of next turn. No wire is disposed at positions opposing the longitudinal end faces of the permanent magnet 410.

{0079} The driving coil 420 with such configuration enables current flow in opposite directions on the N-pole 410n side and the S-pole 410s side through only one coil, so that torques can be simultaneously generated on the N-pole 410n side and the S-pole 410s side. The current flow in the first connecting portion 423 and the second connecting portion 424 generates no torque against the permanent magnet 410. However, since the wires of the portions 423, 424 are short, little energy loss is caused by the resistance thereof. For these reasons, the torque against the permanent magnet 410 can be generated with high energy efficiency through the driving coil 420.

The driving coil 420 can be easily manufactured only by bending a planar single-core coil into a U shape.

{0080} The actuator 400 includes a terminal and a wire for applying a drive signal to the driving coil 420, and the driving coil 420 is not in contact with the permanent magnet 410.

The yoke 430 is a ferromagnetic material disposed outside the driving coil 420, is composed of a first portion 431, a second portion 432 and a third portion 433 respectively formed of a flat plate, and the cross section of the yoke 430 in a plane perpendicular to the longitudinal direction thereof is substantially three sides of a square with one side missing.

{0081} In the actuator 400 of the above configuration, the yoke 430 is disposed in such a way that, on a plane perpendicular to the central axis of the permanent magnet 410, the distance from the central axis of the permanent magnet 410 to the yoke 430 is different according to directions viewed from the central axis of the permanent magnet 410. That is, according to the direction viewed from the permanent magnet 410, the distance between the permanent magnet 410 and the yoke 430 is longer at some direction and shorter at other direction. It can be considered that the distance from the permanent magnet 410 to the yoke 430 is infinite in the direction of the opening side of the square of the yoke 430.

{0082} If the yoke 430 is disposed in this manner, when no voltage is applied to the driving coil 420, the N-pole 410n and the S-pole 410s of the permanent magnet 410 are stopped by the magnetic force toward the direction closest to the yoke 430. In the case where the two poles cannot simultaneously face the “nearest direction”, the poles are stopped toward an appropriate equilibrium direction.

{0083} In the example of FIG. 10, the permanent magnet 410 is stopped such that one of the N-pole 410n and the S-pole 410s approximately face the center of the first portion 431, and the other one approximately faces the center of the second portion 432. Such location is referred to as a “neutral position”. When the permanent magnet 410 is slightly rotated from the neutral position by applying voltage to the driving coil 420, the permanent magnet 410 will return to the neutral position if the voltage is turned off. In this meaning, it is said that a restoring force for returning the permanent magnet 410 to the neutral position acts in the actuator 400. That is, the permanent magnet 410 combined with the yoke 430 operates as a magnetic spring with its natural state at the neutral position.

{0084} The permanent magnet 410 and the mirror 401 perform reciprocating rotation utilizing the restoring force. Accordingly, if the actuator 400 is driven by a specific driving frequency, for example, driven by the resonant frequency of the movable member of the actuator 400 or its approximate frequency, high-speed scanning can be achieved with low power consumption compared with a general galvanometer mirror that does not produce a restoring force.

The distance from the permanent magnet 410 to the third portion 433 is preferably longer than the distance to the first portion 431 or the second portion 432. Even if the distance from the permanent magnet 410 to the third portion 433 is shorter, this orientation does not become a neutral position, because when one pole faces the third portion 433, there is no yoke opposed to the other pole. However, the relationship between the orientation of the permanent magnet 410 and the strength of the restoring force may become locally distorted.

{0085} The principle of reciprocating rotation of the actuator 400 will be described with reference to FIG. 13A to FIG. 14C.

FIG. 13A to FIG. 14C schematically show the cross sections of the permanent magnet 410, the driving coil 420, and the yoke 430 on a plane perpendicular to the permanent magnet 410 as viewed from the mirror 401. Hatchings indicating the cross sections are omitted, and only the first portion 431 and the second portion 432 related to the formation of the neutral position are shown among the yoke 430. Arrows B and B′ indicate representatives of the orientations of magnetic field lines generated by the permanent magnet 410 in each state. Arrows F and F′ indicate the directions of force applied to the permanent magnet 410 in each state. In all cases, the lengths of the arrows do not necessarily correspond to the magnitudes of force.

{0086} If the actuator 400 is held with no voltage applied to the driving coil 420, the permanent magnet 410 stops after rotating to the neutral position shown in FIG. 13A and FIG. 14A. The position at which the N-pole 410n and the S-pole 410s are exchanged from the state of FIG. 13A and FIG. 14A is also the neutral position, in which case the same reciprocating rotation can also be performed. However, the explanation here is made assuming that the position of FIG. 13A is the neutral position.

{0087} Considering that a voltage is applied to the driving coil 420 from the state of FIG. 13A, FIG. 13B shows that current i flows through the first portion 421 from the front side to the rear side, and current -i conversely flows through the second portion 422 from the rear side to the front side.

In this state, a clockwise magnetic field is formed around the first portion 421, a counterclockwise magnetic field is formed around the second portion 422, and a magnetic field having bottom to top magnetic field lines in the figure is formed nearby the permanent magnet 410. The permanent magnet 410 is subjected to an upward force on the N-pole 410n in the magnetic field, and rotates clockwise. This force can be considered as a reaction of Lorentz force generated by the current flowing through the driving coil 420 within the magnetic field generated by the permanent magnet 410.

Then, when the application of voltage to the driving coil 420 is stopped after the permanent magnet 410 is rotated to some extent as shown in FIG. 13C, the permanent magnet 410 returns to the natural state of FIG. 13A because of the magnetic force between the magnetic poles and the yoke 430.

{0088} On the other hand, when voltage in a direction opposite to the case of FIG. 13B is applied to the driving coil 420, and current flows in the opposite direction as shown in FIG. 14B, a magnetic field having top to bottom magnetic field lines in the figure is formed nearby the permanent magnet 410. The permanent magnet 410 is subjected to a downward force on the N-pole 410n in the magnetic field, and rotates counterclockwise.

Then, when the application of voltage to the driving coil 420 is stopped after the permanent magnet 410 is rotated to some extent as shown in FIG. 14C, the permanent magnet 410 returns to the natural state of FIG. 14A (the same state as FIG. 13A) because of the magnetic force between the magnetic poles and the yoke 430.

{0089} The above process is repeated by applying a drive signal having a periodically varying voltage or current to the driving coil 420, and thereby the actuator 400 performs reciprocating rotation (oscillation) of the permanent magnet 410 and the mirror 401.

The angular range of the rotation may be symmetrical with respect to the natural state, or may be asymmetrical. For example, the swing can also be performed within a certain angular range with one end thereof at a position near the neutral position by periodically turning on and turning off the voltage applied to the driving coil 420. The mirror 401 can oscillate within an arbitrary angular range by periodically changing the voltage or current applied to the driving coil 420 within an appropriate range.

{0090} In this case, when the permanent magnet 410 is stopped at the end of the oscillation range, energy is not required for braking, and turning off the application of voltage to the driving coil 420 is enough. Also when the permanent magnet 410 returns from the end of the oscillation range to the neutral position, voltage is not required. When the permanent magnet 410 is rotated from the neutral position to the end of the oscillation range, it is necessary to apply voltage to the driving coil 420 for overcoming the restoring force to the neutral position. However, even if this point is considered, the actuator 400 can oscillate the permanent magnet 410 and the mirror 401 with low power consumption compared with a galvanometer mirror without restoring force.

{0091} If the rotation angle of the permanent magnet 410 is too large while oscillating, the permanent magnet 410 cannot return to the original neutral position when the application of the voltage is stopped, and may return to another neutral position where the N-pole 410n and the S-pole 410s are exchanged. Therefore, the oscillation angular range is preferably not too large. In the example of FIG. 13 and FIG. 14, the permanent magnet 410 should not be rotated up to +90 degree or - 90 degree or more from the initial neutral position.

{0092} In addition, when the displacement from the natural state becomes large, there is also a problem that the energy efficiency will reduce. This is because, when the displacement becomes large, the poles are affected not only by the wires opposed in the natural state but also by the wires on the opposite side. Since the current flows through the wires on the opposite side in the opposite direction, the magnetic force thereof decelerates the rotation.

From these viewpoints, if the angular range of rotation is symmetrical with respect to the natural state, a relatively wider oscillation range can be obtained, and higher energy efficiency can be obtained. Accordingly, the symmetrical oscillation range is preferable.

{0093} In the actuator 400 described above, the permanent magnet 410 is cylindrical, but the shape of the permanent magnet is not limited thereto. The symmetry is high in the cylindrical shape, so that the stability of rotation can be improved. However, if the bearing or the holder can be made in an appropriate shape to hold the permanent magnet 410 to rotate, the cylindrical shape is not required. For example, a prismatic shape is also acceptable. In the case of a cylindrical or a prismatic, not only a longitudinal shape with a height larger than the size of the bottom surface but also a disc shape with a diameter of the bottom surface larger than the height may also be acceptable. The cross-sectional area may also be variable along with the position in the height direction, for example, barrel shape with a larger cross-sectional area near the center or another shape having a larger cross-sectional area near the ends may be adopted.

### 4. Adjusting Driving Frequency of the Actuator (FIG. 15 to FIG. 25)

{0094} Next, an operation of driving frequency control of the actuator, executed by the object detecting apparatus 10, is described. This operation can be similarly applied to both the case of using the actuator 300 and the case of using the actuator 400 as an actuator for deflecting the laser beam L1 in the primary scanning direction. Certainly, the operation can also be applied to the case of using other actuators having a resonant frequency such as ones in which a movable element having a restoring force to a natural state is driven to reciprocally rotate against the restoring force. An example of such actuator is one described in PTL3.

Here, a configuration using the actuator 400 will be described as an example.

{0095} FIG. 15 shows an example of waveform of a drive signal drv_p applied to the driving coil 420 to drive the actuator 400.

As shown in FIG. 15, the drive signal drv_p here is a rectangular wave in which voltages of +v and -v repeat at a constant cycle. When the inverse of this cycle (herein referred to as “driving frequency”) coincides with the resonant frequency of the mirror 401 (and the permanent magnet 410 to which the mirror 401 is fixed) as a movable member, the mirror 401 of the actuator 400 can be driven efficiently, i.e., with low power consumption.

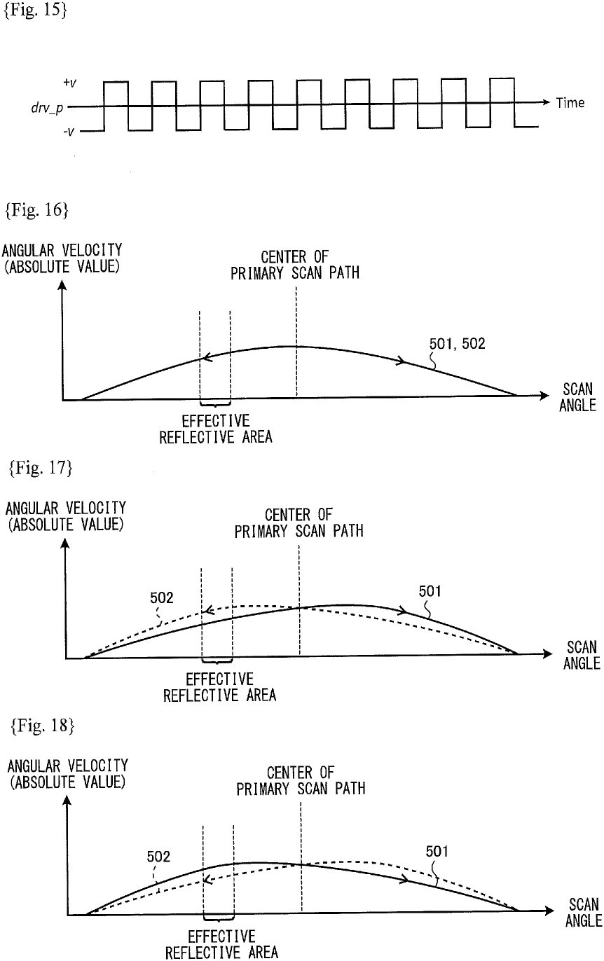

{0096} Here, some examples of relationships between scan angle and absolute value of angular velocity regarding to the mirror 401 are shown FIG. 16 to FIG. 18. FIG. 16 shows an example of the case where the driving frequency coincides with the resonant frequency of the mirror 401, and FIG. 17 and FIG. 18 show examples of the cases where the driving frequency deviates from the resonant frequency of the mirror 401. In FIG. 16 to FIG. 18, position on the swing path of the mirror 401 (expressed by a rotation angle from an appropriate reference position, and this rotation angle is referred to as the “scan angle”) is shown on the horizontal axis, and absolute value of the angular velocity at each position is shown on the vertical axis to illustrate change in velocity. The solid lines 501 indicate the relationships in the forward scan path, and the broken lines 502 indicate the relationships in the backward scan path.

In the following description, the terms “velocity” and “angular velocity” refer to the absolute values thereof unless otherwise specified.

{0097} It is known that the moving speed of the mirror 401 swung by the actuator 400 is not constant. Since the mirror 401 stops at the ends of the swing path and is moving in the other portion, it is clear that there is a variation in the moving speed, and according to the experiments by the inventor, as shown in FIG. 16 to FIG. 18, the speed is generally slower toward the ends of the swing path and faster toward the center.

{0098} Further, according to experiments by the inventor, it has been also found that, in the case of FIG. 16 in which the driving frequency (approximately) coincides with the resonant frequency of the mirror 401, whether the rotation is clockwise or counterclockwise, i.e., in the forward scan path or the backward scan path, the angular velocity is substantially equal at the same position and only the direction of movement is different. In addition, the peak of the angular velocity in each scan path comes to the center of the primary scan path. Therefore, in FIG. 16, the solid line 501 and the broken line 502 overlap each other, and only the solid line 501 appears in the figure.

{0099} On the other hand, according to experiments by the inventor, it has been also found that, when the driving frequency is deviated from the resonant frequency of the mirror 401, as shown in FIG. 17 or FIG. 18, relationships between the scan angle and the angular velocity are different between the forward scan path and the backward scan path. In this case, the peak of the angular velocity in each scan path also deviates from the center of the primary scan path.

In the example of FIG. 17, the peak of the angular velocity is shifted rearward from the center in both the forward scan path and the backward scan path. In the example of FIG. 18, the peak is conversely shifted forward from the center.

{0100} According to experiments by the inventor, it has been also found that, when the driving frequency and the resonant frequency of the mirror 401 are relatively close to each other, while the driving frequency is gradually brought close to the (assumed) resonant frequency and then changed beyond the (assumed) resonant frequency, the relationship between the scan angle and the angular velocity in the reciprocating scanning changes as follows.

That is, at first, the relationship is as shown either in FIG. 17 or FIG. 18, then the difference between the forward scan path and the backward scan path becomes smaller as the driving frequency approaches the resonant frequency, and the relationship shown in FIG. 16 is obtained when the driving frequency reaches a certain value. This value is considered to be the resonant frequency. Thereafter, when the driving frequency is changed beyond the resonant frequency, the relationship becomes as shown in one of FIG. 17 and FIG. 18 again, and the difference between the forward scan path and the backward scan path increases as the driving frequency goes away from the resonant frequency.

In this embodiment, driving frequency of the actuator 400 is controlled to match the driving frequency with the resonant frequency of the mirror 401, utilizing the above relationships between scan angle and angular velocity of the mirror 401.

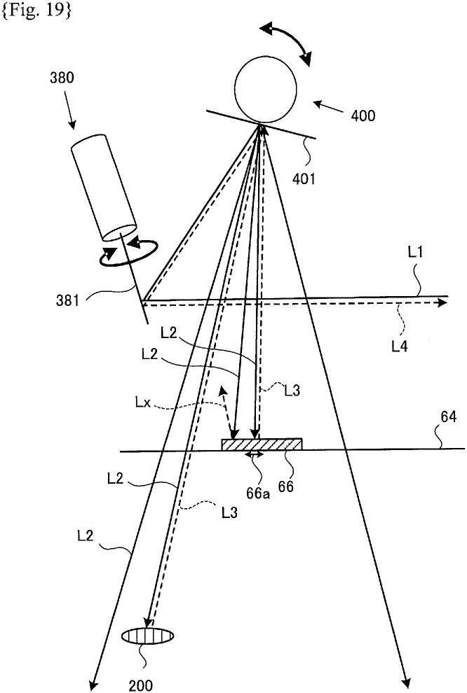

{0101} Next, the principle of the driving frequency control will be described also referring to FIG. 19 to FIG. 24.

FIG. 19 is a schematic diagram illustrating optical paths of the laser beam projected from the scanning assembly 30 and reflected light incident on the scanning assembly 30 in more detail than FIG. 1. In FIG. 19, direction of each optical path is considered only in the primary scanning direction.

In the scanning assembly 30 described here, the actuator 400 is used for the scanning in the primary scanning direction, and the primary scanning lines are formed by changing projecting direction of the outward light L2 through reciprocal rotation of the mirror 401 to reflect the laser beam L1. When the outward light L2 is reflected by the external object 200 or the reflective area 66 on the protective material 64, the reflected light returns to the mirror 401 as a returned light L3. At this time, among the light reflected by the object 200 or the reflective area 66, only the angular portion reflected in the same direction as the outward light L2 and returns to the mirror 401 along the optical path opposite to the outward light L2 is reflected by the mirror 401 and the mirror 381 to be guided to the light receiving portion 40 after passing through the aperture 44 as the returned light L4, and detected by the light-receiving element 43.

{0102} Here, if the reflective surface of the reflective area 66 on the side on which the outward light L2 is incident has a property of specularly reflecting the incident light, the outward light L2 is reflected in the same direction as the incoming light path only when the outward light L2 is incident substantially perpendicularly on the reflective surface. In the example of FIG. 19, the reflective surface of the reflective area 66 is planar, and the above “substantially perpendicularly” condition is satisfied only when the outward light L2 is incident on the effective reflective area 66a indicated by an arrow. Note that, since the beam spot of the outward light L2 has a slight spread, when considering whether or not the reflected light is finally detected by the light-receiving element 43, the effective reflective area 66a has a corresponding extended area, not only a single point. In FIG. 19 to FIG. 24, the effective reflective area 66a is shown relatively broaderly only for better visibility. Actually, the effective reflective area 66a would be very narrower.

{0103} When the outward light L2 is incident on a region other than the effective reflective area 66a, the light is reflected in a different direction than the mirror 401 like the reflected light Lx in FIG. 19, and therefore, the reflected light Lx does not reach the light reception unit 40 and is not detected by the light-receiving element 43. When reflected in the vicinity of the effective reflective area 66a, the reflected light Lx may reach the mirror 401, but such reflected light Lx is blocked by the aperture 44 as described using FIG. 1, and does not reach the light-receiving element 43.

{0104} Therefore, the period during which the light-receiving element 43 detects the reflected light from the reflective area 66 coincides with the period during which the scan passes through the effective reflective area 66a.

Among the reflective area 66, the effective reflective area 66a corresponds to a first reflective area, and the area other than the effective reflective area 66a corresponds to the second reflective area.

The same applies to the secondary scanning direction, but this point will be described later.

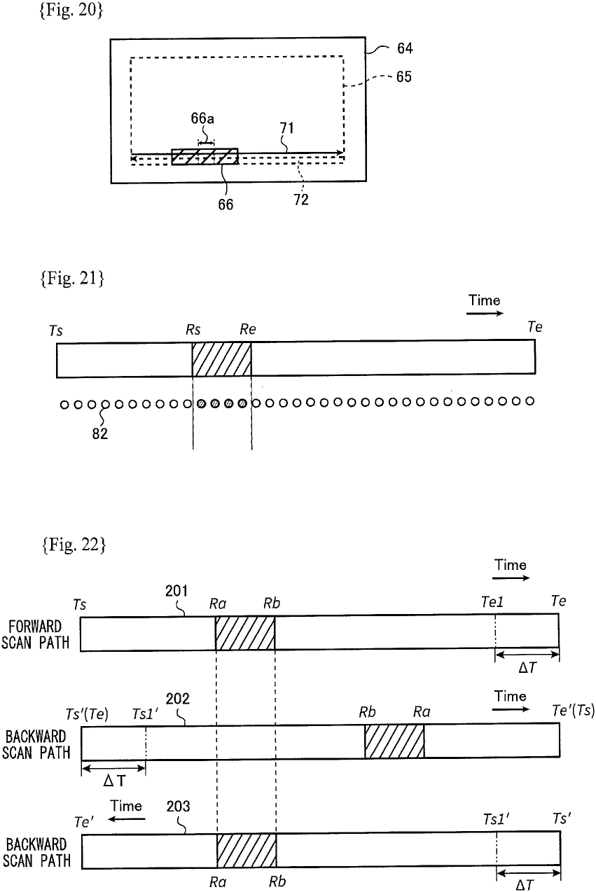

{0105} FIG. 20 illustrates relationship between the scanning range of the outward light L2 and positions of the reflective area 66 and the effective reflective area 66a.

As shown in FIG. 20, the scanning range (field of view) of the outward light L2 indicated by the dotted line 65 is formed in a rectangular shape within the area of the protective material 64 which allows the outward light L2 to transmit therethrough. In the drawing, the horizontal direction is the primary scanning direction, and the vertical direction is the secondary scanning direction. Reference numerals 71 and 72 denote examples of primary scanning lines of the forward and backward scan paths, respectively.

{0106} The reflective area 66 is provided in a predetermined region that extends in the primary scanning direction within a part of the scanning range of the outward light L2 and extends in the secondary scanning direction such that at least a pair of reciprocating primary scanning lines pass therethrough. The reflective area 66 is formed to specularly reflect the incident outward light L2. Thus, when viewed in the primary scanning direction, the outward light L2 being incident on the effective reflective area 66a is reflected toward the same optical path as the outward light L2 as described above.

{0107} The reflective area 66 is provided to include the effective reflective area 66a therein in the primary scanning direction. Although a configuration in which an edge of the reflective area 66 coincides with an edge of the effective reflective area 66a is conceivable, the edge of the reflective area 66 does not need to coincide with the edge of the effective reflective area 66a. Regarding to the primary scanning direction, it is preferable that the reflective area 66 is formed in a wider region than the effective reflective area 66a.

{0108} If an edge of the reflective area 66 coincides (substantially) with an edge of the effective reflective area 66a, a step will be formed or a sudden change in reflectance will occur at the edge of the effective reflective area 66a. As a result, since the beam spot of the outward light L2 has a certain diameter, irregular reflection will occur or a gradual variation in the amount of the reflected light detected by the light-receiving element 43 will occur when the scan passes through the edge. This causes deterioration of accuracy in detecting the edge of the effective reflective area 66a based on the detection of the reflected light by the light-receiving element 43. When some member that scatters the outward light L2 is disposed on the outer side of the effective reflective area 66a, the disadvantage is large.

{0109} On the other hand, if the reflective area 66 is formed to extend outward on both sides in the primary scanning direction of the effective reflective area 66a so that the outward area is smoothly continuous with the effective reflective area 66a with no steps or abrupt change of the reflectance therebetween, irregular reflection does not occur at edges of the effective reflective area 66a, and the amount of light detected by the light-receiving element 43 changes sharply depending on whether or not the specularly reflected light reaches the light-receiving element 43. Therefore, edges of the effective reflective area 66a can be accurately detected based on the detection of the reflected light by the light-receiving element 43.

{0110} The effective reflective area 66a is formed at a position where the outward light L2 is incident on the reflective surface substantially perpendicularly, regardless of the position of the reflective area 66 itself. Therefore, even if the position of the reflective area 66 is slightly shifted in the primary scanning direction, if the position to be the effective reflective area 66a is included in the reflective area 66, detection of the reflected light from the effective reflective area 66a will not be affected. By providing the reflective area 66 in a region larger than the effective reflective area 66a, the assembly error of the reflective area 66 can be tolerated in this sense.

{0111} The reflective area 66 as described above can be formed by disposing, for example, a thin metal film on the protective material 64 as a part of the object detecting apparatus 10, but the material and the forming method are not limited thereto. The reflective area 66 may be formed at a position away from the protective material 64 if it is within the scanning range of the outward light L2. The reflective area 66 may be located either of inside and outside the protective material 64.

{0112} Regarding to the secondary scanning direction, position of the reflective area 66 and angle of the reflective surface thereof is preferably adjusted so that the entire reflective area 66 becomes the effective reflective area 66a. This is because it is not necessary to detect positions of the edges of the effective reflective area 66a in the secondary scanning direction for adjusting driving frequency of the primary scanning direction, and therefore it is not necessary to pay attention to detection accuracy of the edges in the secondary scanning direction. Further, if the reflective area 66 is provided in a width to accommodate at least two primary scanning lines (a pair of reciprocating primary scanning lines) in the secondary scanning direction, adjustment of the driving frequency can be performed without particular control on the scanning in the secondary scanning direction. With this degree of width, the entire area can be used as the effective reflective area 66a even if the reflective surface is a flat surface.

Note that, in the case where a particular control is performed for stopping the scanning in the secondary scanning direction at a position corresponding to the reflective area 66 while one reciprocating scanning in the primary scanning direction passing through the reflective area 66 is performed, it is sufficient that the reflective area 66 has a width to accommodate one primary scanning line in the secondary scanning direction.

{0113} Further, in FIG. 19 and FIG. 20, the reflective area 66 is disposed at a position somewhat away from the center of the primary scanning line for the sake of clarity of the following description, but the present invention is not limited thereto, and the reflective area 66 may be provided near the center or near the end of the primary scanning line. However, in consideration of adjustment of the scanning range that is described later, an arrangement too close to an end of the primary scanning line is not preferable. It is preferable to arrange the reflective area 66 such that the primary scanning line passes through the effective reflective area 66a no matter how narrow the scanning range is, within the adjustable range.

{0114} FIG. 21 is a diagram for explaining a method of detecting a time period during which the outward light L2 is reflected by the reflective area 66.

When the object detecting apparatus 10 performs object detection, the LD module 21 is intermittently turned on to form the scanning lines 71 and 72 as a series of beam spots 82 as described in FIG. 1. When the beam spot 82 is incident on the effective reflective area 66a and is reflected by the effective reflective area 66a, the TDC circuitry 52 outputs a signal indicating a particular time difference corresponding to the distance from the effective reflective area 66a to the light-receiving element 43, which is the time difference between the timing t0 of the lighting pulse and the timing t1 of the pulse of the corresponding returned light L4. When the processor circuitry 53 detects the signal indicating the particular time difference regarding to some beam spot, the processor circuitry 53 can determine that the outward light L2 forming the beam spot was reflected by the effective reflective area 66a.

{0115} Further, since it is considered that an object nearer than the protective material 64 will not be detected, it is conceivable to prepare a threshold value corresponding to a distance longer than the distance to the protective material 64 by an error degree, and to determine that the outward light L2 was reflected by the effective reflective area 66a when the detected time difference is smaller than the threshold value. A process for performing this determination is a determining step, and when this determination is performed, the processor circuitry 53 functions as a determining assembly.

The signal indicating the time difference, output by the TDC circuitry 52 may be in exactly the same format as in the case where the reflected light reflected from the external object 200 is detected. Simply outputting a signal indicating that the time difference between t0 and t1 is small is sufficient.

{0116} Since the effective reflective area 66a has a certain width in the primary scanning direction, when the primary scanning line passes through the effective reflective area 66a, a certain number of beam spots constituting the primary scanning line are reflected by the effective reflective area 66a. In FIG. 21, these spots are shown by hatched dots. The processor circuitry 53 can specify, based on the turn-on timings of the respective spots reflected by the effective reflective area 66a, a time period during which the outward light L2 is incident on the effective reflective area 66a in one primary scanning line. In FIG. 21 to FIG. 24, the time periods are indicated by hatched area, and the respective time points corresponding to the left and right ends of the effective reflective area 66a in FIG. 20 are indicated by Ra and Rb, respectively. Ra and Rb can be recognized as timings of the optical edge timings at which the presence or absence of reflected light detection by the light-receiving elements 43 is switched, and the time period between Ra and Rb will be hereinafter called “detection timing” of the reflected light (reflected by the effective reflective area 66a).

{0117} Further, the processor circuitry 53 can refer to the timings of voltage inversion of the drive signal drv_p of the actuator 400 as timings of the start point and the end point of each primary scanning. In FIG. 21 to FIG. 24, the start point of the forward primary scan path is indicated by Ts, the end point thereof is indicated by Te, the start point of the backward primary scan path is indicated by Ts′, and the end point thereof is indicated by Te′.

{0118} As described above, the processor circuitry 53 can obtain information on the time period during which the laser beam is reflected by the reflective area 66 in each primary scanning, by using hardware and algorithm for the object detection as they are.

Note that the end portions of the primary scanning lines may be hidden, and thus the forward scanning period and the backward scanning period may not be continuous if these periods are considered as periods for forming effective primary scanning lines. However, in this embodiment, one primary scan is defined as the period from when the mirror 401 that performs reciprocating rotation starts rotating at one end of the swing path to when the mirror reaches the other end of the swing path, stops and changes the rotation direction. According to this definition, the forward scan and the backward scan are substantially continuously performed. That is, Te of one forward scan path and Ts′ of the next backward scan path coincide with each other, and Te′ of one backward scan path and Ts of the next forward scan path coincide with each other.

{0119} FIG. 22 to FIG. 24 illustrates time periods during which light reflected from the effective reflective area 66a is detected during one primary scan in the case where the scan angle and the angular velocity of the mirror 401 are in the relationship illustrated in FIG. 16 to FIG. 18, respectively. In these figures, it is assumed that the driving frequency is not changed between the forward scan path and the backward scan path, and the time (Te -Ts or Te′ - Ts’) required for one primary scan is the same in the forward scan path and the backward scan path.

{0120} When the driving frequency shown in FIG. 22 coincides (substantially) with the resonant frequency of the mirror 401, in the forward scan path, the outward light L2 is reflected by the effective reflective area 66a at a time point slightly earlier than the center of the scanning period, and the reflected light is detected by the light-receiving element 43 as shown by the graph 201. This corresponds to the configuration that the effective reflective area 66a is arranged in the first half of the forward scan path. On the other hand, in the backward scan path, the reflected light is detected by the light-receiving element 43 at a time point slightly later than the center of the scanning period, as shown by the graph 202.

Further, in this state, since the relation between the scan angle and the angular velocity of the mirror 401 is the same in the forward scan path and the backward scan path as shown in FIG. 16, when the outputs of the TDC circuitry 52 regarding to the respective beam spots in the backward scan path are arranged in the reverse order, the reversed outputs will (almost) coincide with the outputs in the forward scan path, as shown in the graph 203.

{0121} That is, in the forward scan path and the backward scan path, the time intervals between respective timings at which the outward light L2 is reflected by a particular position of the effective reflective area 66a and respective timings at which the scanning reaches an end of the scanning line (the timings at which the mirror 401 changes rotational direction at an end of the swing path) coincide. Note that, the “end” here is one end (a predetermined end) located on the same side of the field of view, in both the forward scan path and the backward scan path. That is, for example, Ra - Ts in the forward scan path is equal to Te′ - Ra in the backward scan path. In addition, Te - Rb in the forward scan path is equal to Ts′ - Rb in the backward scan path.

{0122} In these examples, the forward scan path and the backward scan path are compared with each other using reference timings (first reference scan timings) of: the anterior end of the detection timing of the reflected light in the forward scan path and the posterior end of the detection timing of the reflected light in the backward scan path (Ra); or the posterior end of the detection timing of the reflected light in the forward scan path and the anterior end of the detection timing of the reflected light in the backward scan path (Rb), and Both of Ra and Rb correspond to one edge of the effective reflective area 66a. However, both of Ra and Rb may be used as reference timings. In addition, the same holds true even when the comparison is made with respect to any reference timings other than the edge of the effective reflective area 66a. In any case, it can be said that the first reference scan timings are timings determined based on the detection timing of the reflected light reflected by the effective reflective area 66a during the primary scan.

{0123} On the other hand, the other reference timings of Ts, Te, Ts′, and Te′ correspond to second reference scan timings determined based on the timing at which the primary scan reaches a predetermined end. Here, an example in which the exact timings at which the primary scan reaches the predetermined end are used as the second reference scan timings will be described. However, timings (Tel and Tsl′ are shown as examples) deviated from the exact timing by an arbitrary time ΔT as shown in FIG. 22 may be used. The present driving frequency adjustment is focusing on comparison between the forward scan path and the backward scan path as will be described later, and even if the second reference scan timings are deviated by the same value ΔT from the exact timing in both the forward scan path and the backward scan path, the comparison result is not affected. Accordingly, the present driving frequency adjustment can be substantially performed as if the exact timings are used as the second reference scan timings, even when the deviation of ΔT exists.

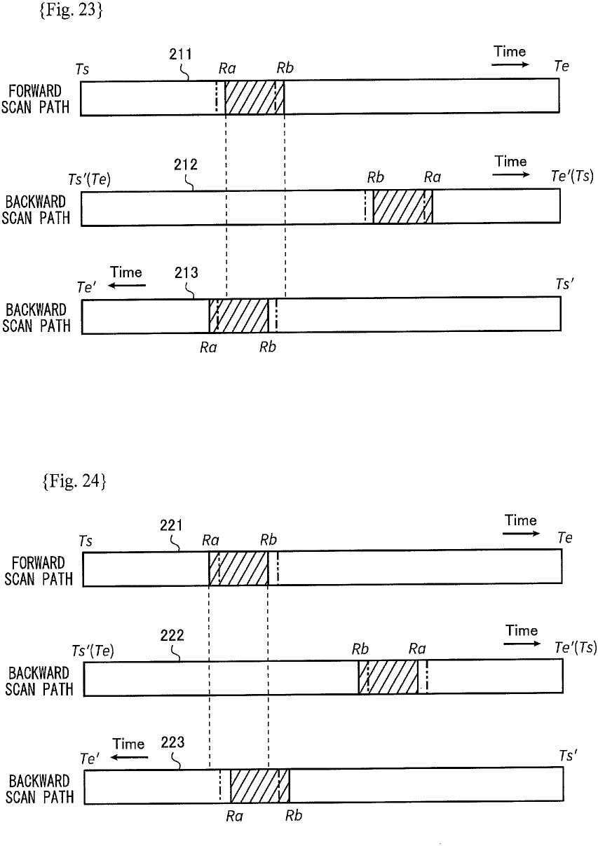

{0124} On the contrary to the example of FIG. 16, under the condition that the angular velocity is larger in the latter half of the scan path as shown in FIG. 17, the detection timings of the reflected light from the effective reflection region 66a are shifted to the latter side as compared with the case of FIG. 22 in both the forward scan path and the backward scan path, as shown in FIG. 23. In FIG. 23, graphs 211 to 213 corresponds to graphs 201 to 203 respectively.

On the other hand, under the condition that the angular velocity is larger in the former half of the scan path as shown in FIG. 18, the detection timings of the reflected light from the effective reflection region 66a are shifted to the former side as compared with the case of FIG. 22 in both the forward scan path and the backward scan path, as shown in FIG. 24. In FIG. 24, graphs 221 to 223 corresponds to graphs 201 to 203 respectively. In FIG. 23 and FIG. 24, the positions indicated by the imaginary lines are the positions of the detection timings in FIG. 22.

{0125} Therefore, when the driving frequency does not coincide with the resonant frequency of the mirror 401, the time interval between the first reference scan timing (for example, Rα for both the forward and backward scan paths) and the second reference scan timing (for example, Ts of the forward scan path and Te′ of the backward scan path) differs between the forward scan path and the backward scan path.

In addition, when the deviation between the driving frequency and the resonant frequency is reduced, the difference in the time interval is also reduced.

From the above, if the driving frequency of the actuator 400 is adjusted so that the time interval between the first reference scan timing and the second reference scan timing along the forward scan path and that along the backward scan path (substantially) become equal, the driving frequency can be set at the resonant frequency of the mirror 401, and thus a power efficient drive can be performed.

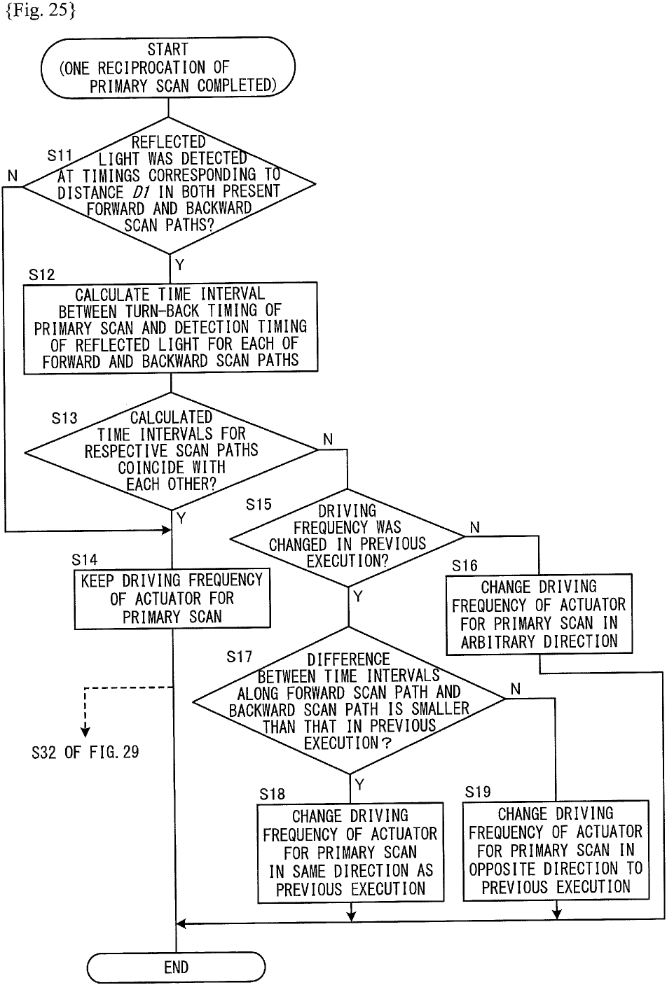

{0126} Next, a process of adjusting driving frequency based on the scheme above, executed by the processor circuitry 53, will be described using FIG. 25. FIG. 25 is a flowchart of the process. This process can be realized by software, and can also be realized by dedicated hardware. This process corresponds to a frequency adjusting step, and the processor circuitry 53 that executes this process functions as a frequency adjusting assembly.

When the processor circuitry 53 detects that one reciprocation of the primary scan is completed, the processor circuitry 53 starts the process of FIG. 25.

{0127} In this process, the processor circuitry 53 first determines whether or not some reflected light was detected at the timing corresponding to the distance Dl to the effective reflective area 66a in both the present forward and backward scan paths (S11). This determination can be made based on the signal output by the TDC circuitry 52. In addition, a distance equal to or less than a predetermined threshold may be used as the determination criterion instead of the specific distance Dl. If No in step S11, since the driving frequency cannot be adjusted based on the present reciprocation of the primary scan, the processor circuitry 53 keeps the present driving frequency (S14) and terminates the process.

{0128} If Yes in step S11, the processor circuitry 53 calculates the time interval between the turn-back timing of the primary scan (the timing at which the primary scan reaches a predetermined end: an example of the second reference scan timing) and the detection timing of the reflected light (an example of the first reference scan timing) for each of the forward scan path and the backward scan path (S12), and determines whether or not the time interval along the forward scan path and the time interval along the backward scan path coincide with each other within a predetermined tolerance (S13).

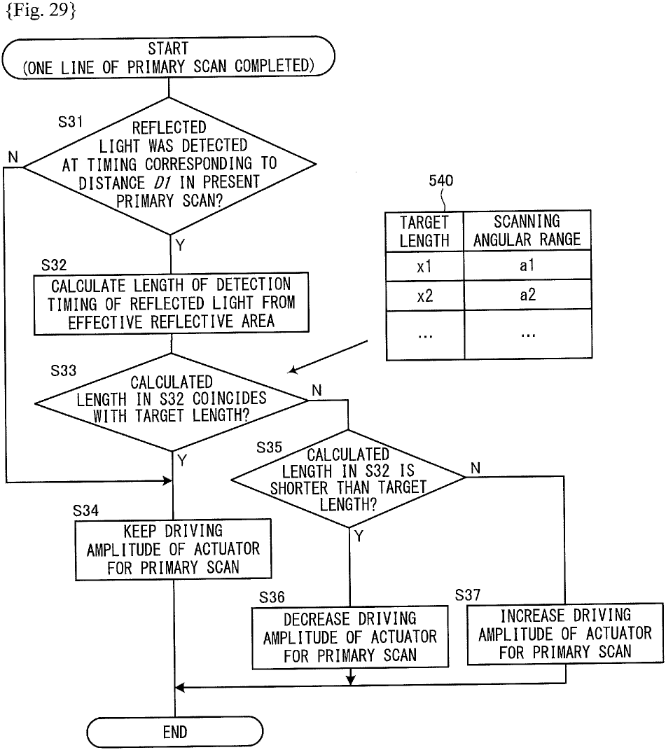

{0129} If Yes in step S13, it can be determined that the present driving frequency coincides with the resonant frequency of the mirror 401, and thus the processor circuitry 53 keeps the present driving frequency (S14) and terminates the process. The processor circuitry 53 may execute step S32 and subsequent steps in FIG. 29 after step S14. This point will be described later.

If No in step S13, the processor circuitry 53 determines whether or not the driving frequency was changed in the previous execution of the process of FIG. 25 (S15). If No here, the processor circuitry 53 changes the driving frequency by an appropriate mount in an arbitrary direction (S16) and terminates the process.

{0130} If Yes in step S15, the processor circuitry 53 determines whether or not the difference between the time intervals along the forward scan path and the backward scan path presently calculated in step S12 is smaller than that calculated in the previous execution of the process of FIG. 25 (S17). If Yes here, it can be determined that the change in the driving frequency during the previous execution was in a direction approaching the resonant frequency, and thus the processor circuitry 53 changes the driving frequency by an appropriate amount in the same direction as the previous execution (S18), and terminates the process.

{0131} If No in the step S17, it can be determined that the change in the driving frequency during the previous execution was in a direction leaving away from the resonant frequency, and thus the processor circuitry 53 changes the driving frequency by an appropriate amount in the opposite direction to that in the previous execution (S19), and terminates the process.

In both step S18 and S19, the appropriate amount may be varied in accordance with the difference calculated in step S12.

{0132} It should be noted that it is not essential to calculate the time-difference as a numerical value in step S12. For example, it is conceivable to create a bit string indicating the spots in primary scanning lines by representing spots where reflected light from the distance D1 is detected as “1” and the other spots as “0”, sort the bit string of the backward scan path in reverse order, and then compare the bit strings of the forward scan path with that of the backward scan path, thereby determining how well they match.

{0133} Further, instead of executing the process of FIG. 25 each time one reciprocation of the primary scan is completed, the time interval may be calculated in step S12 after completion of multiple reciprocations, based on the results of the multiple reciprocations. Further, the driving frequency may be changed after the scanning of one frame within the field of view is completed.

{0134} According to the above-described method, except that the reflective surface 66 is added, driving frequency of the actuator 400 for performing the primary scanning can be adjusted to coincide with the resonant frequency of the mirror 401, using hardware for object detection as it is. In addition, the present method is less susceptible to noise and temperature changes in comparison with the method of detecting zero-cross points through a back electromotive force as described in the summary section. Therefore, it is possible to provide a function of adjusting the driving frequency with a very small additional cost.

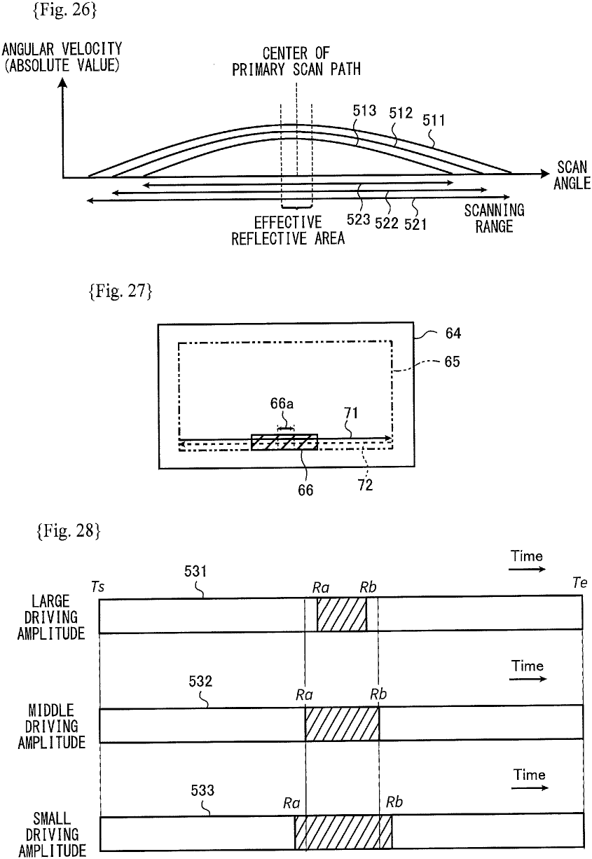

### 5. Adjusting Driving Amplitude of the Actuator (FIG. 26 to FIG. 31)

{0135} Next, an operation of driving amplitude control of the actuator, executed by the object detecting apparatus 10 described above, will be described. This operation is also applicable to any type of actuators having a resonant frequency as in the case of the driving frequency control described above. Here, a configuration using the actuator 400 will be described as an example.

The driving amplitude here is an amount of energy of the drive signal applied to the driving coil 420 of the actuator 400, and is typically the amplitude of the drive signal drv_p shown in FIG. 15. However, it is also possible to change the amount of energy without changing amplitude of the drive signal by duty control or the like.

{0136} Firstly, FIG. 26 shows examples of relationship between scan angle and angular velocity of the mirror 401. The indication of each axis is the same as that in FIG. 16 to FIG. 18.

In FIG. 26, graphs 511 to 513 respectively show relationships between scan angle and angular velocity under conditions in which the driving amplitude is different from one another but the driving frequency of the actuator 400 coincides with the resonant frequency of the mirror 401. The graph 511 is under the condition with the largest driving amplitude and the driving amplitude decreases in the order of 512 and 513.

{0137} According to experiments conducted by the inventor, when the driving amplitude is changed in a state where the driving frequency coincides with the resonant frequency, graphs showing relationships between the scan angle and the angular velocity changes in a generally similar manner as shown in FIG. 26. This means that, when compared at the same scan angle, the larger the driving amplitude is, the larger the angular velocity becomes at all positions. Further, as indicated by arrows 521 to 523 corresponding to the graphs 511 to 513, the larger the driving amplitude is, the wider the scanning range becomes. It is also found that the resonant frequency is substantially constant regardless of the driving amplitude. Strictly speaking, the resonant frequency slightly varies, but not at a level to substantially affect the drive amplitude adjustment described here.

The driving amplitude control of the actuator 400 in this embodiment is performed in order to arbitrarily adjust the scanning range in the primary scanning direction utilizing such characteristics.

{0138} Next, the principle of the driving amplitude control will be described with reference to FIG. 27 and FIG. 28. The points not specifically noted are the same as those for the driving frequency control described above.

First, FIG. 27 illustrates relationship between the scanning range of the outward light L2 and positions of the reflective area 66 and the effective reflective area 66a in the same manner as FIG. 20.

In this example, as shown in FIG. 27, the reflective area 66 is provided at the center of the primary scanning line, and the effective reflective area 66a is also located at the center of the primary scanning line. This is only for easy understanding of this section. It is also conceivable that the reflective area 66 is provided at a position slightly away from the center, and the effective reflective area 66a is also located at that position, as in the case of FIG. 20. However, it is preferable to provide the reflective area 66 so that the effective reflective area 66a does not deviate from the scanning range even if the driving amplitude varies. In addition, if only the driving amplitude control is considered, it is sufficient to form the reflective area 66 and the effective reflective area 66a with a width to accommodate one primary scanning line in the secondary scanning direction.

{0139} Next, FIG. 28 illustrates, in the same manner as FIG. 22, time periods during which light reflected from the effective reflective area 66a is detected during one primary scan in each condition shown in FIG. 26. The graphs 531 to 533 shown in FIG. 28 correspond to the graphs 511 to 513 in FIG. 26, respectively.

In the exemplary embodiment described here, since the effective reflective area 66a is provided at the center of the primary scanning line and the driving frequency coincides with the resonant frequency of the mirror 401, as shown in FIG. 28, the time period (from Rα to Rb) during which the reflected light from the effective reflective area 66a is detected comes to the center of the primary scanning period. This holds regardless of the driving amplitude. In addition, in both the forward and backward scan paths, Rα and Rb come to the same positions (precisely, along the backward scan path, Rb is the first, Rα is the second, and the order is reversed from along the forward scan path).

{0140} On the other hand, the time length (Rb - Rα) during which the reflected light from the effective reflective area 66a is detected varies depending on the scanning angular range.

The reason is as follows. First, the area in which the effective reflective area 66a exists does not change due to the driving amplitude when considered in terms of scan angle. Then, as shown in FIG. 26, if scan angle is the same, the larger the driving amplitude is, the larger the angular velocity becomes. Therefore, the larger the driving amplitude is, the shorter the time required for the scan to pass through the effective reflective area 66a becomes, that is, the shorter the time period during which the reflected light from the effective reflective area 66a is detected becomes. Further, the larger the driving amplitude is, the larger the scanning angular range becomes. Therefore, the larger the scanning angular range is, the shorter the period during which the reflected light from the effective reflective area 66a is detected becomes.

{0141} Accordingly, scanning in a desired scanning angular range can be easily realized in the object detecting apparatus 10 by storing data of premeasured relation between the length of the period (corresponding to first period, and also to the “detection timing” of the reflected light in the previous section) during which the light-receiving element 43 detects the reflected light from the effective reflective area 66a and the scanning angular range in an arbitrary storage, and adjusting the driving amplitude so that length of the detection timing of the reflected light becomes a target value corresponding to a desired scanning angular range appropriately referring to the stored relation. The storage may be an external device.

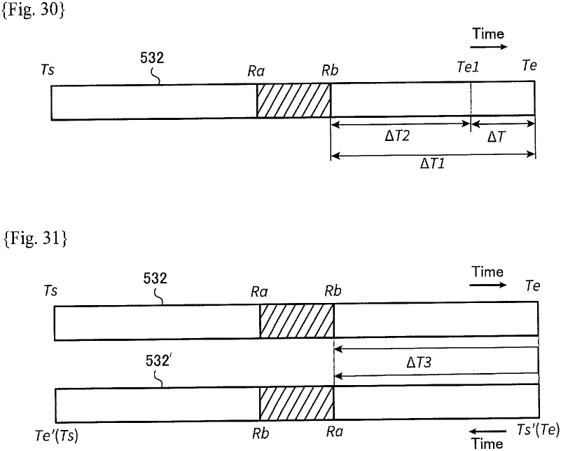

Note that “length of the detection timing becomes a target value corresponding to a desired scanning angular range” is merely one example of target conditions (reference for adjusting the driving amplitude) that the detection timing of the reflected light from the effective reflective area 66a during the reciprocating scanning should satisfy. Other examples of the reference will be described later with reference to FIG. 30 and FIG. 31.

{0142} Next, a process of adjusting driving amplitude based on the above concept, executed by the processor circuitry 53, will be described with reference to FIG. 29. FIG. 29 is a flowchart of the process. This process can be realized by software, and can also be realized by dedicated hardware. This process corresponds to an amplitude adjusting step, and the processor circuitry 53 that executes this process functions as an amplitude adjusting assembly.

When the processor circuitry 53 detects that one line of the primary scan is completed, the processor circuitry 53 starts the process of FIG. 29.

{0143} In this process, the processor circuitry 53 first determines whether or not the reflected light was detected at the timing corresponding to the distance Dl to the effective reflective area 66a in the present primary scan (S31). This determination can be performed in the same manner as in step S11 of FIG. 25.

If No in step S31, since the driving amplitude cannot be adjusted based on the present primary scan, the processor circuitry 53 keeps the present driving amplitude (S34) and terminates the process.

If Yes in step S31, the processor circuitry 53 calculates length of the detection timing of the reflected light within the present primary scan (S32), and determines whether or not the calculated length coincides with a predetermined target length (S33). This target length is, for example, a value predetermined and corresponded with a desired scanning angular range and registered in a table 540 stored in an appropriate storage device, but is not limited thereto.

{0144} If Yes in step S33, it can be determined that the present driving amplitude is an appropriate value, and thus the processor circuitry 53 keeps the present driving amplitude (S34), and terminates the process.

If No in step S33, the processor circuitry 53 adjusts the driving amplitude toward the target value according to whether the reflection timing is shorter than the target value or not (S35 to S37), and terminates the process.

{0145} The above-described process may be executed after completion of multiple lines of the primary scan, and the length of the detection timing may be calculated based on the results of the multiple scanning lines in step S32, instead of executing the above-described process each time one line of the primary scan is completed. Further, the driving amplitude may be changed after the scanning of one frame within the field of view is completed.

{0146} According to the above-described method, except that the reflective surface 66 is added, driving amplitude of the actuator 400 for performing the primary scanning can be adjusted to obtain a desired scanning angular range.

This makes it possible to easily adjust the viewing angle of object detection by the object detecting apparatus 10. Thus, even when the number of beam spots in one primary scanning line is fixed in consideration of processing speed of the processor circuitry 53 and the like, it is possible to easily switch between detection with relatively low resolution in a wide range and detection with high resolution in a relatively narrow range.

{0147} This is a function corresponding to telephoto and zoom of optical cameras. That is, when the scanning range is narrowed without changing lighting interval of the LD module 21, the number of detection points per angle can be increased, and object detection with higher resolution can be performed although the field of view is narrowed.

In a case of scanning using, for example, a polygon mirror, since the maximum scanning angular range is determined by the number of facets of the polygon, in order to increase resolution of the object detection, it is necessary to shorten the lighting interval of the laser light source (increase driving frequency of the light source). As a result, lifespan of the laser light source is greatly reduced, or power consumption of the laser light source is greatly increased. On the other hand, in the object detecting apparatus 10 described above, it is possible to detect an object with high resolution without adversely affecting lifespan and power consumption of the laser light source.

{0148} Note that the process of FIG. 29 is preferably performed in a state where the driving frequency of the actuator 400 coincides with the resonant frequency of the mirror 401. In this aspect, it is preferable to execute the process of step S32 and the subsequent steps in FIG. 29 after step S14 in FIG. 25. However, even if the driving frequency of the actuator 400 does not coincide with the resonant frequency of the mirror 401, it is possible to adjust the driving amplitude with a certain degree of accuracy, and it is of course also possible to independently perform the process of FIG. 29.

In addition, in order to calculate the detection period of the reflected light, it is not essential to measure the time. For example, when beam spots in the primary scanning line are at equal time intervals, the reflection period can be calculated based on the number of the beam spots reflected by the effective reflective area 66a and detected by the light-receiving element 43.

{0149} Next, other examples of reference for adjusting the driving amplitude will be described referring to FIG. 30 and FIG. 31.

First, it is conceivable to adjust the driving amplitude such that a time interval, between a first reference scan timing determined based on detection timing of the light reflected from the effective reflective area 66a in the primary scan and a second reference scan timing determined based on a timing when the primary scan reaches an end of the scanning range, becomes a predetermined target length.

{0150} FIG. 30 shows the same graph 532 as in FIG. 28. As described with reference to FIG. 28, when the driving frequency is constant, Te - Ts is constant, whereas length of the period (Rb - Rα) during which the reflected light from the effective reflective area 66a is detected varies depending on the scanning angular range. When the length of Rb - Rα varies, as shown in FIG. 28, the time period during which the reflected light is detected in one primary scan is widened toward both sides.

Therefore, the smaller the driving amplitude is and thus the longer the time period during which the reflected light is detected in one primary scan is, the smaller the time interval (ΔTl in FIG. 30) between the timing at which the reflected light from the effective reflective area 66a is detected (for example, Rb in FIG. 30) and the timing at which the primary scan reaches an end (for example, Te in FIG. 30) becomes.

{0151} By calibrating relationship between the value of ΔTl and the scanning angular range in advance, and adjusting the driving amplitude such that the value of ΔTl becomes a target value corresponding to the desired scanning angular range, the same driving amplitude adjustment as that described with reference to FIG. 28 and FIG. 29 can be performed. In this case, the processor circuitry 53 calculates the value of ΔTl in step S32, and in steps S35 to S37, the processor circuitry 53 increases the driving amplitude when ΔTl is smaller than the target value, whereas decreases the driving amplitude when ΔTl is larger than the target value.

{0152} Note that, as in the case of the driving frequency adjustment described above, Rα may be used as the first reference scan timing, an arbitrary position other than an edge of the effective reflective area 66a may be used as a reference for the first reference scan timing, and Ts with respect to the opposite end portion or a timing (for example, Tel) deviated from the end by an arbitrary time ΔT may be used as the second reference scan timing. When Tel is used instead of Te as the second reference scan timing, the value of ΔT2 shown in FIG. 30 should be calculated and compared with the target value.

{0153} Fatherly, based on a similar idea, it is conceivable to adjust the driving amplitude such that a time interval ΔT3 shown in FIG. 31 becomes a predetermined target value. ΔT3 is a time interval between a first reference scan timing (for example, Rb in the graph 532 of FIG. 31) determined based on detection timing of the reflected light from the effective reflective area 66a during one primary scanning and a second reference timing (for example, Rα in the graph 532′ of FIG. 31) determined based on detection timing of the reflected light from the effective reflective area 66a during another primary scanning subsequent to the one primary scanning. ΔT3 = ΔTl × 2, and the smaller the driving amplitude is, the smaller the ΔT3 becomes.

{0154} All of these examples are substantially based on the concept described with reference to FIG. 28, wherein the driving amplitude is adjusted such that length of the period during which the outward light L2 is incident on the effective reflective area 66a among the scanning period becomes an appropriate value corresponding to the target value of the scanning angular range. These examples differ only in the point where the measurement reference is placed. It is of course also conceivable to perform such adjustment using other target conditions.

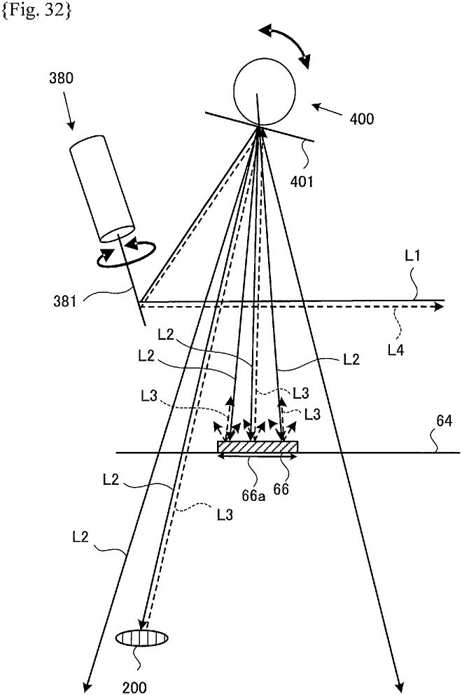

### 6. Comparative Example (FIG. 32)

{0155} Next, a comparative example of the embodiment will be described. This comparative example is an example in which the reflective area 66 diffusely reflects the incident light. FIG. 32 corresponding to FIG. 19 schematically illustrates optical paths of the laser beam projected from the scanning assembly 30 and the reflected light to be detected by the light-receiving element 43 in this example.

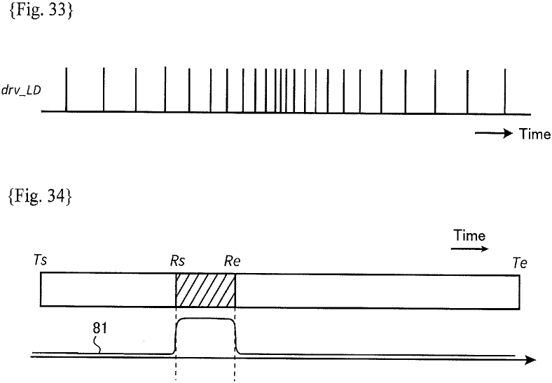

In the example of FIG. 32, the reflective area 66 is formed by a member that diffusely reflects incident light, such as a diffuser. In this case, light reflected from respective points on the reflective area 66 includes a component travelling along the same direction as the incident direction (indicated by reference L3 in FIG. 33), although the reflected light also includes a component travelling along a direction other than the incident direction. Therefore, the reflected light from anywhere on the reflective area 66 is detected by the light-receiving element 43. Therefore, the entire area of the reflecting surface of the reflective area 66 becomes the effective reflective area 66a.

{0156} In this case, edges of the effective reflective area 66a and edges of the reflective area 66 coincide with each other, and as described with reference to FIG. 20, accuracy of detecting edges of the effective reflective area 66a is deteriorated. Therefore, accuracy of the driving frequency adjustment and the driving amplitude adjustment described in the embodiment is also deteriorated.

Compared to the embodiment described above, because the reflective area 66 is configured to specularly reflect laser beam and the reflective area 66 is provided in a wider area than the effective reflective area 66a, it is possible to improve accuracy of detecting edges of the effective reflective area 66a, and it is also possible to improve accuracy of the driving frequency adjustment and the driving amplitude adjustment.

### 7. Modified Examples (FIG. 33 and FIG. 34)

{0157} Next, modified examples of the embodiment will be described. The modifications described here can be commonly applied to the driving frequency adjustment and the driving amplitude adjustment, unless otherwise specified. In the description of the modified examples, the same reference numerals as in the embodiment described above are used for portions common to or corresponding to the embodiment.

{0158} In the embodiment described above, an example in which the reflecting surface of the reflective area 66 is planar has been described. However, in both the primary scanning direction and the secondary scanning direction, the reflecting surface of the reflective area 66 may be a concave surface centered at the reflection point where the outward light L2 is reflected by the mirror 401, the radius thereof being the distance from the reflection point to the reflective area 66. In this case, the entire reflective area 66 serves as the effective reflective area 66a. Such concave surface may be cylindrical only satisfying one of the primary scanning direction and the secondary scanning direction, or a spherical surface satisfying for both scanning directions.

{0159} Further, if the concave surface having a larger radius than the above (the radius may vary at positions) is adopted, a portion of the reflective area 66, wider than the case of the flat surface shown in FIG. 19, can be used as the effective reflective area 66a, while the reflective area 66 can be formed to be smoothly continuous with the effective reflective area 66a on both sides thereof in the primary scanning direction. In this case, the reflective area 66 reflects the outward light L2 such that the reflected light returns substantially along the incident optical path thereof only, within a somewhat wide incident angle, and thus it can be said that the reflective surface 66 retroflects the outward light L2.

{0160} Fatherly, as another aspect, in the embodiment described above the period during which the reflected light from the reflective area 66 is detected by the light-receiving element 43 is counted. However, even if the period during which the reflected light from the reflective area 66 is not detected by the light-receiving element 43 among the primary scanning period is counted, it is substantially the same as counting the period during which the reflected light is detected, and the same adjustment can be performed.

{0161} Fatherly, when the entire area of the reflective area 66 is the effective reflective area 66a, it is not necessary to distinguish a first period during which the outward light L2 is scanning within the effective reflective area 66a (the reflective area 66) from a second period other than the first period based on whether the light-receiving elements 43 is detecting the reflected light or not. For example, it is conceivable to form the reflective area 66 as an area having a reflectance different from that of the remaining area along the same primary scanning line, and distinguish whether the light has been reflected by the reflective area 66 or not based on the detected intensity of the reflected light. Based on the result of the distinction, it is possible to determine whether or not the outward light L2 is scanning within the reflective area 66 at respective time points of the primary scanning period.

{0162} In this case, it is conceivable that the reflectance of the reflective area 66 is lower than the reflectance of the other portion. For example, the laser beam may be transmitted in a region corresponding to the reflective area 66 on the primary scanning line whereas the laser beam is reflected in the other region. Anyway, if it is possible to distinguish the first period during which the outward light L2 is incident on a region corresponding to the effective reflective area 66a from the second period other than the first period based on the result of detection of the reflected light, it is enough.

{0163} Fatherly, as a further aspect, so far we have described an example in which the LD module 21 is turned on at equal time intervals within the primary scanning line for the sake of simplicity of explanation. However, in practice, it is conceivable to turn on the LD module 21 at a longer time interval near the ends of the scanning range where the angular velocity is small and at a shorter time interval near the center thereof where the angular velocity is large, in order to form beam spots at equal angular intervals within the field of view (see, for example, PTL3). In this case, the drive signal drv_LD of the LD module 21 is as shown in FIG. 33, for example.

The embodiment described above can be applied even when the LD module 21 is turned on at non-constant time intervals like this case. This is because, if the processor circuitry 53 is supplied with the information on the respective lighting times based on the drive signal drv_LD, the processor circuitry 53 can obtain Rα and Rb based on the lighting times of the beam spots of which the reflected light is detected by the light-receiving elements 43.

{0164} Fatherly, the embodiment described above is applicable even when the LD module 21 is continuously turned on during the primary scan. In this case, as shown by the graph 81 in FIG. 34, the intensity of the light detected by the light-receiving element 43 increases while the laser light is reflected by the effective reflective area 66a as compared with the other period, due to the reflected light. The processor circuitry 53 can calculate the timings of Rα and Rb as timings at which edge of the intensity change appears based on intensities of light detected by the light-receiving elements 43 at respective time points.

{0165} Fatherly, the embodiment described above, an example in which the driving frequency adjustment and the driving amplitude adjustment are performed only in the primary scanning direction has been described. However, in the case of adopting an actuator having a resonant frequency such as the actuator 300 or the actuator 400 also in the secondary scanning direction, it is possible to perform the driving frequency adjustment and the driving amplitude adjustment in the same way also in the secondary scanning direction.

{0166} In this case, since no scanning lines linearly scan in the secondary scanning direction, it is conceivable to assume virtual secondary scanning lines in which beam spots having the same position in the primary scanning direction are connected in the secondary scanning direction, and provide the reflective area 66 at a predetermined region that is a part of the scanning range in the secondary scanning direction and has a width to accommodate at least a pair of reciprocating secondary scanning lines (one secondary scanning line in consideration of only the driving amplitude control). In this case, it is preferable to provide the reflective area 66 such that a part of the width of the reflective area 66 becomes the effective reflective area 66a as described with reference to FIG. 19 and FIG. 20, also in the secondary scanning direction.

{0167} Then, the timings (Ts and Te) of the start and completion of the secondary scanning can be grasped based on timings of the voltage inversion of the drive signal of the actuator for the secondary scanning direction, and the time range (Rα and Rb) during which the outward light L2 is reflected by the effective reflective area 66a can also be grasped based on reflected light of which beam spot was detected by the light-receiving element 43 and at which time the beam spot was projected. Therefore, the same processing as in FIG. 25 and FIG. 29 can be performed based on these values.

{0168} In addition, in the present invention, the specific configuration of the apparatus, the specific operation procedure, the specific shape of the components, and the like are not limited to those described in the embodiment.

The features described in the above sections may be independently applied to an apparatus or a system, respectively. In particular, the above-described driving frequency adjustment, driving amplitude adjustment, and detection of reflection from the effective reflective area 66a can be applied to an optical scanning device that is not intended for object detection.

{0169} Fatherly, an embodiment of a computer program of the present invention is a computer program or programs for causing one computer or a plurality of computers to cooperate, to control required hardware to realize a function including all or a part of the driving frequency adjustment, the driving amplitude adjustment, and the detection of reflection from the effective reflective area 66a described above, or to execute the process described in the above embodiment.

{0170} Such a program may be stored in a ROM or other non-volatile storage medium (a flash memory, an EEPROM, etc.) of a computer. The program may also be provided as any non-volatile storage medium such as a memory card, a CD, a DVD, or a Blue-ray disc storing the program. The program may also be downloaded from an external apparatus connected to a network and installed on a computer to run.

{0171} Certainly, configurations of the embodiment and the modified examples described above can be arbitrarily combined as long as they do not contradict each other, and only a part of them can be taken out for implementing.

### Reference List

{0172} 10... object detecting apparatus, 20... light projecting unit, 21.... LD module, 22... laser drive circuitry, 23... collimating optical assembly, 30... scanning assembly, 31... mirror, 32... actuator, 40... light reception unit, 41, 48... mirror, 42... collective lens, 43... light-receiving element, 44... aperture, 51... front-end circuitry, 52...TDC, 53... processor circuitry, 54... input/output unit, 61... top cover, 62... rear cover, 63... cover clip, 64... protective material, 65... field of view, 66... reflective area, 66a... effective reflective area, 70... field of view, 71, 72... scanning line, 82... beam spot, 200... object, 300, 380, 400 ...actuator, 301... mirror unit, 301a... first mirror, 301b... second mirror, 302... torsion spring, 304, 384, 404... rotation axis, 311... core yoke, 312... frame yoke, 313... coil assembly, 314... top yoke, 315... screw, 316... drive coil, 317... sensing coil, 320... movable member, 321... permanent magnet, 321s... S-pole, 321n... N-pole, 381, 401... mirror, 382... shaft, 383... holder, 402... mirror holder, 403, 405... bearing, 406... magnet holder, 410... permanent magnet, 410s... S-pole, 410n... N-pole, 420... driving coil, 421, 422... first and second portions of drive coil, 423, 424... first and second connecting portions of drive coil, 430...yoke, 431 to 433... first to third portions of yoke, L1.... laser beam, L2... outward light, L3, L4... returned light, Lx, Ly... reflected light

1. A light scanning apparatus, comprising:
a scanning assembly configured to reciprocally scan a predetermined scanning range in a first direction with a laser beam by projecting the laser beam reflected by a reflective member periodically driven by an actuator to rotate reciprocally, the reciprocating scan including a forward scan path and a backward scan path;
a light detector configured to receive and detect light at a predetermined position;
a retrospective optics comprising the reflective member and a collective optics, and configured to guide a first light to the light detector, the first light being incident on the reflective member;
a measuring assembly configured to measure time of flight (ToF) value between projection of the laser beam and reception of light by the light detector;
an object detecting assembly configured to detect a distance to an object related to direction of each projection of the laser beam, based on the ToF value measured by the measuring assembly regarding to the each projection of the laser beam;
a first reflective area configured to specularly reflect the laser beam, at a predetermined portion partly overlapping the scanning range in the first direction; and
a frequency adjusting assembly configured to adjust a driving frequency to be applied to the actuator such that, regarding to a time interval between a first reference scan timing determined based on detection timing of a light reflected from the first reflective area in a scan and a second reference scan timing determined based on a timing when the scan reaches a predetermined end of the scanning range, a first value of the time interval along the forward scan path passing through the first reflective area and a second value of the time interval along the backward scan path passing through the first reflective area substantially become equal.

2. The light scanning apparatus according to claim 1,
wherein the first reflective area has a generally specular reflective surface configured to specularly reflect the projected laser beam incident thereon substantially into a direction where the retrospective optics guides the reflected laser beam to the light detector, and
the specular reflective surface of the first reflective area is extended at least along the first direction to form a second reflective area and the second reflective area is smoothly continuous with the first reflective area, the second reflective area being configured to specularly reflect the projected laser beam incident thereon to a direction different to that where the retrospective optics guides the reflected laser beam to the light detector.

3. The light scanning apparatus according to claim 1,
wherein the frequency adjusting assembly uses:
an anterior end of the detection timing of the light reflected from the first reflective area in the forward scan path and a posterior end of the detection timing of the light reflected from the first reflective area in the backward scan path; or
a posterior end of the detection timing of the light reflected from the first reflective area in the forward scan path and an anterior end of the detection timing of the light reflected from the first reflective area in the backward scan path,
as the first reference timing.

4. The light scanning apparatus according to claim 1,
wherein the scanning assembly is configured to scan the scanning range with the laser beam in a primary scanning direction that is the first direction, and in the secondary scanning direction different from the primary scanning direction, and
the first reflective area is positioned only in a part of the scanning range in the secondary scanning direction such that at least a pair of reciprocating primary scanning lines pass therethrough.

5. The light scanning apparatus according to claim 1, further comprising
a determining assembly configured to determine that the projected laser beam is reflected from the first reflective area when the ToF value measured by the measuring assembly is less than a predetermined threshold.

6. The light scanning apparatus according to claim 1, further comprising
an amplitude adjusting assembly configured to adjust a driving amplitude to be applied to the actuator such that a first period length during which the light detector detects the light reflected from the first reflective area or a second period length during which the light detector does not detect the light reflected from the first reflective area, within one scanning period of a first scan passing through the first reflective area, becomes a predetermined targeted period length.

7. The light scanning apparatus according to claim 6,
wherein the amplitude adjusting assembly is configured to adjust the driving amplitude in a state where the first value and the second value of the time interval are substantially equal.

8. The light scanning apparatus according to claim 2, further comprising
an amplitude adjusting assembly configured to adjust a driving amplitude applied to the actuator such that a first period length during which the light detector detects the light reflected from the first reflective area or a second period length during which the light detector does not detect the light reflected from the first reflective area, within one scanning period of a first scan passing through the first reflective area, becomes a predetermined targeted period length.

9. The light scanning apparatus according to claim 8,
wherein the amplitude adjusting assembly is configured to adjust the driving amplitude in a state where the first value and the second value of the time interval are substantially equal.

10. An adjustment method of a light scanning apparatus, comprising:
preparing a light scanning apparatus comprising: a scanning assembly configured to reciprocally scan a predetermined scanning range in a first direction with a laser beam by projecting the laser beam reflected by a reflective member periodically driven by an actuator to rotate reciprocally, the reciprocating scan including a forward scan path and a backward scan path; a light detector configured to receive and detect light at a predetermined position; a retrospective optics comprising the reflective member and a collective optics, and configured to guide a first light to the light detector, the first light being incident on the reflective member; a measuring assembly configured to measure time of flight (ToF) value between projection of the laser beam and reception of light by the light detector; an object detecting assembly configured to detect a distance to an object related to direction of each projection of the laser beam, based on the ToF value measured by the measuring assembly regarding to the each projection of the laser beam; and a first reflective area configured to specularly reflect the laser beam, at a predetermined portion partly overlapping the scanning range in the first direction; and
adjusting a driving frequency to be applied to the actuator such that, regarding to a time interval between a first reference scan timing determined based on detection timing of a light reflected from the first reflective area in a scan and a second reference scan timing determined based on a timing when the scan reaches a predetermined end of the scanning range, a first value of the time interval along the forward scan path passing through the first reflective area and a second value of the time interval along the backward scan path passing through the first reflective area substantially become equal.

11. A non-transitory machine-readable storage medium storing program instructions executable by a processor configured to control a light scanning apparatus comprising: a scanning assembly configured to reciprocally scan a predetermined scanning range in a first direction with a laser beam by projecting the laser beam reflected by a reflective member periodically driven by an actuator to rotate reciprocally, the reciprocating scan including a forward scan path and a backward scan path; a light detector configured to receive and detect light at a predetermined position; a retrospective optics comprising the reflective member and a collective optics, and configured to guide a first light to the light detector, the first light being incident on the reflective member; a measuring assembly configured to measure time of flight (ToF) value between projection of the laser beam and reception of light by the light detector; an object detecting assembly configured to detect a distance to an object related to direction of each projection of the laser beam, based on the ToF value measured by the measuring assembly regarding to the each projection of the laser beam; and a first reflective area configured to specularly reflect the laser beam, at a predetermined portion partly overlapping the scanning range in the first direction,
and when executed, causing the processor to execute:
adjusting a driving frequency to be applied to the actuator such that, regarding to a time interval between a first reference scan timing determined based on detection timing of a light reflected from the first reflective area in a scan and a second reference scan timing determined based on a timing when the scan reaches a predetermined end of the scanning range, a first value of the time interval along the forward scan path passing through the first reflective area and a second value of the time interval along the backward scan path passing through the first reflective area substantially become equal.
